(19) United States
(12) Patent Application Publication
(10) Pub. No.: US 2018/0365723 A1
(43) Pub. Date: Dec. 20, 2018

(54) INTEGRATED VALUE EXCHANGE AND REFERRAL SYSTEM

(71) Applicant: GigBee, Hiawatha, IA (US)

(72) Inventor: Kristoffer LENTZ, Snohomish, WA (US)

(21) Appl. No.: 16/010,278

(22) Filed: Jun. 15, 2018

Related U.S. Application Data
(60) Provisional application No. 62/520,409, filed on Jun. 15, 2017.
(60) Provisional application No. 62/520,416, filed on Jun. 15, 2017.
(60) Provisional application No. 62/520,422, filed on Jun. 15, 2017.

(51) Int. Cl. G06Q 30/02

(52) U.S. Cl. CPC G06Q 30/0214; G06Q 30/0276

(57) ABSTRACT

This disclosure describes techniques that facilitate a presentation of one or more product-service campaign(s) in a centralized location of an electronic marketplace. More specifically, an Integrated Value Exchange and Referral (IVER) system is described that may provide affiliate providers (APs) with a capability to generate product-service campaign(s) that filter and aggregate a set of product-service offerings for presentation to consumers, based on predetermined selection criteria. APs may include vendors, sellers, or merchants that deal present product-service offerings through the IVER system. The product-service offerings may be presented via an IVER consumer portal, from which each consumer may elect to view or purchase a selection of product-service offerings or refer the same to other consumers via a selected communications medium.

### RELATED APPLICATIONS

This applicant claims priority to co-pending, commonly owned U.S. Provisional Patent Application No. 62/520,409 filed on Jun. 15, 2017 and titled “Integrated Value Exchange and Referral Platform,” U.S. Provisional Patent Application No. 62/520,416 filed on Jun. 15, 2017 and titled “Affiliate Provider Integration with an Integrated Value Exchange and Referral (IVER) Platform,” and U.S. Provisional Patent Application No. 62/520,422 filed on Jun. 15, 2017 and titled “Client Integration with an Integrated Exchange and Referral (IVER) Platform,” which are herein incorporated by reference in their entirety.

### BACKGROUND

In recent years, offering products and services over an electronic marketplace has come into wide use. In general, with an internet-based shopping system, a consumer may access a website, view product and/or service specifications, and authorize a purchase transaction. To make comparisons with cheaper products and/or services, however, a consumer must browse the internet and repeat window shopping at different websites.

In current electronic marketplace environments, consumers are presented with a wide variety of buying options. A consumer may be presented a large number of similar products and/or services, and though similar, may be priced very differently. Consequently, faced with perhaps a confusing array of choices, an average consumer may not be incentivized to select one product and/or service over another, and may be similarly hesitant to recommend selection of a product and/or service to another consumer. In some cases, consumers may find it difficult to determine whether or not they are getting the best deal or at least a fair deal.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of an Integrated Value Exchange and Referral (IVER) system.

FIG. 2 illustrates a block diagram of an IVER system process for registering an Affiliate Provider with the IVER system and further generating a product-service campaign.

FIG. 3 illustrates a block diagram of an IVER system process for establishing a product-service campaign and further executing a purchase transaction of a product-service offering via an IVER application.

FIG. 4 illustrates a block diagram of an IVER system process for facilitating a first consumer referral of a product-service offering to a second consumer, and further executing a purchase agreement and payment of a commission benefit to the first consumer and Affiliate Provider (AP).

FIGS. 5A through to 5C illustrate block diagrams of a general platform of an IVER application and a white-label platform of an IVER application. FIG. 5A illustrates a general platform of an IVER application. FIG. 5B illustrates a white-label platform of an IVER application. FIG. 5C illustrates a block diagram of a typical campaign.

FIG. 6 illustrates an example architecture of an Integrated Value Exchange and Referral (IVER) system.

FIG. 7 illustrates an example architecture of a client device that is configured to execute an IVER application associated with the IVER system.

FIG. 8 illustrates a user interface of an IVER application that facilitates an Affiliate Provider (AP) creating, modify, or remove a product-service campaign associated with the IVER system.

FIG. 9 illustrates a user interface of an IVER application that presents a consumer with a product-service offering associated with a product-service campaign.

FIGS. 10A and 10B illustrate exemplary user interfaces of an IVER application for creating a consumer storefront of consumer-preferred product-service offerings. FIG. 10A illustrates an exemplary user interface for generating a consumer storefront based on product-service categories. FIG. 10B illustrates an exemplary user interface for generating a consumer storefront based on a selection of product-service campaigns.

FIG. 11 illustrates an IVER system process for processing a registration request with the IVER system.

FIG. 12 illustrates an IVER system process for generating a product-service campaign for presentation on a user interface of an IVER application.

FIG. 13 illustrates an IVER system process for synchronizing product-service offering data stored within the IVER system, with product-service offering data that resides on one more AP electronic storefronts.

FIG. 14 illustrates an IVER system process for generating a list of AP product-service campaigns that are intended for or are currently being presented to consumers via a consumer portal of an IVER application.

FIG. 15 illustrates an IVER system process that facilitates a tracking of purchase event initiated by a consumer via a consumer portal of an IVER application.

FIG. 16 illustrates an IVER system process that monitors and synchronizes product-service offering data associated with purchase events initiated via a consumer portal of an IVER application.

FIG. 17 illustrates an IVER system process that facilitates payment of a commission benefit in response to approval of a purchase event.

FIG. 18 illustrates an IVER system process to generate a list of existing campaigns based at least in part on performance metrics.

FIG. 19 illustrates an IVER system process for generating, via an AP analysis model, one or more recommendations of product-service offerings for a subset of consumers.

FIG. 20 illustrates an IVER system process for facilitating a consumer generating a consumer storefront at a consumer portal of an IVER application that prioritizes a presentation of consumer-preferred product-service offerings.

### DETAILED DESCRIPTION

This disclosure describes techniques that facilitate a presentation of one or more product-service campaign(s) in a centralized location of an electronic marketplace. More specifically, an Integrated Value Exchange and Referral (IVER) system is described that may provide affiliate providers (APs) with a capability to generate product-service campaign(s) that filter and aggregate a set of product-service offerings for presentation to consumers, based on predetermined selection criteria. APs may include vendors, sellers, or merchants that deal present product-service offerings through the IVER system. The product-service offerings may be presented via an IVER consumer portal, from which each consumer may elect to view or purchase a selection of product-service offerings or refer the same to other consumers via a selected communications medium.

In various examples, the IVER system may be configured to present one or more product-service campaign(s) to consumers via a consumer portal of an IVER application. The IVER application may be native to consumer client device(s) or accessible via a web-based portal that is communicatively connected to the IVER system. The term “campaign” as used herein relates to an offering of a tangible or intangible product or service. A campaign may offer consumers a discount for purchasing a particular product or service or provide a consumer with incentive for referring the same to another consumer. For example, a product-service campaign may offer a commission for product-service transactions that are executed in response to a referral from a consumer. In other words, the IVER system may incentivize a first consumer to refer a product-service campaign to a second consumer by offering the first consumer a commission that is payable in response to a transaction being executed by the second consumer. The commission may comprise any monetary or non-monetary form of compensation, such as a monetary currency transferred to financial account of the first consumer, or to another entity (i.e. a charity specified by the first consumer). Further, the commission may be accrued as stored monetary value in an account of the first consumer that is IVER system. The commission may be calculated as a fixed monetary or non-monetary value (i.e. rewards points). Alternatively, the commission may be calculated as a percentage of the purchase price of the product-service offering, such as 5%, 10%, and/or so forth. Depending on the agreement set by the affiliate provider (AP) associated with the product-service offering, the commission may even exceed the purchase price.

Moreover, the IVER system may be configured to interact with APs and consumers via an IVER application installed on their respective client devices. The IVER application may include a consumer portal and an AP portal that each provide consumers and APs with a selection of access privileges and options. For example, the consumer portal of an IVER application may be configured to provide consumers with access to one or more product-service campaign(s) presented via the IVER system. A consumer may search, purchase, comment, or refer product-service offerings via the consumer portal. In some examples, a consumer may generate a consumer store-front that aggregates, and filters product-service offerings based on selection criteria, such as a category of products or services, or a selection of product-service campaigns. The AP portal of an IVER application may be configured to provide APs with one or more selectable options to establish, monitor, update, or remove product-service campaign(s) presented to consumer via the IVER system. In one example, the AP portal may facilitate transmission of product-service offering data to the IVER system. The product-service offering data may include a title or headline of the product-service, a corresponding category and description, an availability, a purchase price, and a product-service link through which the product-service offering may be accessible to consumers for purchase via an AP electronic storefront. The AP electronic storefront may correspond to an AP platform or an electronic marketplace platform. An AP platform may be a platform through which an AP offers an exclusive selection of product-service offerings, such as a website exclusively associated with the AP. In contrast, an electronic marketplace platform may be a non-exclusive platform through which multiple APs offer product-service offerings. It is noteworthy that the AP electronic storefront is different from the consumer storefront generated via the consumer portal of the IVER application. The consumer storefront is intended to configure a presentation of product-service offerings to the consumer. In response to a consumer selection to view, purchase, or refer a product-service offering, via a consumer portal of the IVER application (i.e. as presented via the consumer storefront), the IVER system may cause the user interface of the IVER application to redirect the consumer to the AP electronic storefront to complete a corresponding transaction.

While the consumer storefront is intended to present product-service offerings to the consumer and the AP electronic storefront facilitates execution of a corresponding transaction, the IVER system is further configured to synchronize product-service offering data (i.e. a title or headline of the product-service, a corresponding category and description, an availability, a purchase price, and a product-service link through which the product-service offering may be accessible) as presented via the consumer portal, with product-service offering data that resides at the AP electronic storefront (i.e. AP platform or electronic marketplace platform). The benefit of doing so ensures that consumers searching for product-service offerings at a consumer storefront via an IVER application, receive real-time up-to-date product-service data, such as a product names, descriptions, prices, availability, and other data pertinent to a campaign. The IVER system may synchronize product-service offering data continuously, on a predetermined schedule, or in response to a triggering event. The predetermined schedule may correspond to a time interval of 30 minutes, 1 hour, 6 hours, or 12 hours. Any time interval is possible. Further, the triggering event may correspond to a consumer selection of a product-service offering via a consumer portal (i.e. consumer storefront), or receipt of a message from an electronic storefront indicating an update to pertinent product-service offering data. The IVER application may also dynamically update existing product-service campaigns, or create new product-service campaigns, to reflect a consumer's current search trends and search terms. For example, a consumer may search for a particular product-service offering via the consumer portal of the IVER application. In doing so, IVER system may dynamically retrieve product-service offerings that match the consumer's search trend and/or search terms, and selectively update an existing product-service campaign or create a new product-service campaign.

The IVER system may provide an AP with selectable options to present one or more product-service campaign(s) to consumers at their respective consumer portals, via a white-label platform, a general platform, or a combination of both. A white-label platform may be configured to exclusively present a selection of product-service offerings associated with the AP or selected by the AP for presentation. For example, an AP of “Brand A” products may exclusively present product-service offerings associated with “Brand A” on the white-label platform. In some cases, however, the AP may selectively present product-service offerings associated with “Brand B” on the same white-label platform. In doing so, an AP is afforded the benefit of filtering out and aggregating a listing of product-service offerings for presentation to consumers, via a consumer portal of the IVER application, preemptively filtering out product-service offerings of competing APs, and further customizing the look, feel and experience of the white-label platform to convey an intended brand image to consumers.

In contrast, a general platform is configured to present and inter-mingle multiple product-service campaign(s) from different AP(s), each of which relate only by the similarities in categories of product-service offerings. Thus, a consumer that searches for a product-service offering via an IVER application configured as a general platform may receive a listing of product-service offerings associated with multiple, different APs.

In a non-limiting example, consider a first AP that deals with “Brand A” and “Brand B” sporting merchandise. First AP may be competing with second AP that deals with a similar category of product-service offerings, namely “Brand C” sporting merchandise. The first AP may generate a white-label platform that presents product-service offerings associated with “Brand A” and “Brand B.” The white-label platform may be accessible to a consumer via a consumer portal of their respective IVER application. Thus, a consumer that searches for sporting merchandise via a consumer portal that accesses the white-label platform of the first AP, is presented with product-service offerings exclusively associated with “Brand A” and “Brand B,” excluding a presentation of competing “Brand C” merchandise of the second AP. Alternatively, the first AP may selectively present product-service offerings associated with “Brand A” and “Brand B” on a general platform that is shared with other APs, including the second AP. Thus, a consumer that searches for sporting merchandise via a consumer portal that accesses the general platform, may view and compare sporting merchandise from competing APs, namely the first AP (i.e. “Brand A” and “Brand B”) and the second AP (i.e. “Brand C”).

Therefore, the consumer portal may be configured to present a consumer with one AP's product-service campaigns via a white-label platform, or multiple APs' product-service campaigns via a general platform. In each case, the consumer portal is further configured to present consumers with selectable options to view, purchase, comment, or refer each product-service campaign. In the event that a consumer elects to view or purchase a product-service offering via the IVER application (i.e. through the consumer portal), the IVER system may cause the user interface of the IVER application to redirect the consumer to the AP electronic storefront (i.e. AP platform or an electronic marketplace platform) to view an additional description associated with the product-service offering or complete a corresponding transaction. In this example, the IVER system may transmit a data packet to the AP electronic storefront that includes an AP identifier that uniquely identify the AP to the IVER system, and further facilitates tracking progress of a transaction (i.e. purchase event) for the product-service offering at the AP electronic storefront. In response to verifying that a consumer has completed the transaction to purchase the product-service offering (i.e. a paid event status), the IVER system may record the purchase event, and further cause an account of the AP to reflect a pending or available commission benefit that will be available once the purchase event has been approved (i.e. an approved event status).

In another example, a first consumer may elect to refer a product-service offering via the IVER application to a second consumer. In doing so, the IVER system may be configured to transmit a product-service referral to a second client device of the second consumer. In this example, the first consumer may configure a product-service referral as text data, video data, image data, audio data, or any combination thereof. Further, the first consumer may further select the communication medium by which the product-service offering may be delivered and presented on the second client device. In one example, the product-service referral may be presented on an IVER application associated with the second client device. Alternatively, or additionally, the first consumer may elect to deliver the product-service referral as a Short Message Service (SMS) message, a Multimedia Message Service (MMS) message, a Rich Communication Service (RCS) message, an electronic mail (e-mail) message, a voice message (i.e. voicemail), or any other known communication medium capable of transmitting and presenting multimedia content to the second client device.

In each of these examples, the IVER system may generate and deploy a referral data packet with the product-service offering to a second client device associated with the second consumer. The referral data packet may include an identifier that uniquely identifies the first consumer to the IVER system, and further facilitates tracking progress of a transaction (i.e. purchase event) for the product-service offering by the second consumer, via the second client device. In this example, the referral data packet may also include another identifier that uniquely identifies the AP that first presented the product-service offering via the IVER system. In doing so, and in response to verifying that the second consumer has completed a purchase transaction (i.e. a paid event status), the IVER system may cause accounts of the first consumer and AP to reflect a pending commission benefit that will be available once the purchase event has been approved (i.e. an approved event status).

In various examples, the IVER system may generate one or more recommendations for an AP, based at least in part on analysis of performance metrics associated with existing product-service offerings within the IVER system and environmental data gather by the IVER system. The recommendations may relate to identifying a set of consumers registered with the IVER system that may be likely to initiate or complete a purchase transaction for a particular product-service offering. Recommendations may also relate to tailoring aspects of product-service offerings to appeal to the set of consumers. For example, a recommendation may suggest a discount to a product-service offering within a geographic area based on any economy of data relating to the set of consumers.

Performance metrics may include, but are not limited to, most-shared product-service offerings, most-clicked product-service offerings, most-purchased product-service offerings, highest-commission product-service offerings, or any combination thereof. Further, performance metrics may be based on campaign data over a predetermined time period. In some examples, performance metrics may be normalized to account for product-service campaigns that have been active for different periods of time.

Further, the IVER system may generate recommendations for an AP, based on environmental data gathered over a predetermined time period. Environmental data may be directly or tangentially related to product-service offerings, and may include, but not limited to, product-service search data performed by a consumer via an IVER application, a geographic location of consumers that initiate and complete a purchase transaction, a time of day, or day of the week that purchase transactions are most often initiated and completed, along with client profile data associated with consumers that initiate and complete a purchase transaction via an IVER application. Client profile data may include demographic data, categories of product interest, categories of service interest, or any combination thereof.

Environmental data may be gathered while a consumer is using an IVER application. Moreover, the IVER system may generate a client analysis model with data points that represent a correlation between environmental data and campaign data associated with APs of the IVER system, over a predetermined time period. In some examples, the IVER system may further incorporate performance metrics of the campaign data into the client analysis model for the purpose of analytically identifying a likely candidate product-service to offer to a consumer based available environment data.

Further, the IVER system may employ one or more machine learning algorithms to identify a product-service offering that is likely to trigger a consumer to initiate and/or complete a corresponding purchase agreement, based on an analysis of a client analysis model. The one or more machine learning algorithms may make use of supervised learning, unsupervised learning, semi-supervised learning, naive Bayes, Bayesian networks, decision trees, neural networks, fuzzy logic models, multiclass decision forest, and/or probabilistic classification models.

In a non-limiting example, consider a client performing a product-search via an IVER application. In this example, the IVER system may monitor the consumer's use of the IVER application, and gather environment data, such as product search terms, a geographic location of the consumer at a point in time that the search was initiated, a time of day or day of the week that the product-search was initiated, or any combination thereof. In doing so, the IVER system may employ one or more trained machine learning algorithms to identify a corresponding product-service offering for the consumer, via the IVER application, based on a correlation of the environmental data and data-points within a client analysis model. In this example, the IVER system may have generated the client analysis model by correlating historical environmental data associated with the consumer and campaign data associated with APs registered with the IVER system. Campaign data may include descriptions of product-service offerings along with performance metrics that identify most-shared, most-clicked, most-purchased, or highest commission product-service offerings. Therefore, the IVER system, independent of search-results that presented to the consumer as a result of their product-search, may transmit a message to one or more APs with a recommendation to transmit an unsolicited product-service offering to the consumer, based on correlation of the consumer's environmental data and the AP's campaign data. Further, the IVER system may also recommend tailoring the product-service offering to suit environmental data, such as geographic location and demographic data, along with a recommendation to transmit the product-service offering at a time of day or day of the week that is most likely to trigger the consumer to initiate and/or complete a corresponding purchase agreement.

In one example, the IVER system may generate an AP (AP) analysis model for the purpose of generating one or more recommendations of product-service offerings for a subset of consumers. The subset of consumers may be determined based on a frequency of visits or residence within a geographic area serviced by the AP, or a degree of correlation between consumer profile data and product-service offerings within the AFD model, or a combination of both.

The IVER system may generate the AP analysis model using any combination of historical product-service transaction data, consumer profile data, and environmental metadata. The historical product-service transaction data may include a record of historical product-service transactions executed within a geographic area, over a predetermined time interval. The consumer profile data may relate to consumers that executed the historical product-service transactions, and may include demographic data, categories of product interest, categories of service interest, or any combination thereof.

Environmental metadata may be directly or tangentially related to product-service offerings, and may include weather metadata, social sentiment metadata, economic metadata, or any combination thereof. The IVER system may selectively capture environmental metadata associated with a geographic area serviced, or targeted for service, by an AP. For example, the IVER system may employ one or more machine-learning algorithms to capture weather metadata from publicly-accessible weather resources that survey the geographic area, such as, but not limited to, the National Oceanic Atmospheric Association (NOAA). Weather metadata may include temperature, humidity, and precipitation measures that are forecast to affect the geographic area. Further, the IVER system may employ one or more machine learning algorithms to capture economic metadata from a government entity such as the Bureau of Labor Statistics, or an equivalent non-government entity. Economic metadata may include employment metadata, cost-of-living expenses, and mean salary of residents within the geographic area. Social sentiment metadata is intended to reflect a sentiment or mood of a set of consumers, in response to the macro-effects of the region or community at large. Social sentiment metadata may relate to societal issues (i.e. personal, regional, or community activism for political or welfare matters) or noteworthy occasions (i.e. Mother's Day, Father's Day, etc.) affecting a set of consumers. Moreover, the IVER system may employ one or more trained machine learning algorithms to capture social metadata from publicly-accessible news sources, social media platforms, or a combination of both. With regards to social media platforms, the IVER system may analyze news-feeds and social media posts associated with the set of consumers.

The one or more trained machine learning algorithms may make use of techniques such as supervised learning, unsupervised learning, semi-supervised learning, naive Bayes, Bayesian networks, decision trees, neural networks, fuzzy logic models, and/or probabilistic classification models.

In one example, the AFD model may analyze environmental metadata relative to historical product-service transaction data of product-service offerings executed within a geographic region over a predetermined time interval. In this way, the AFD model may develop a correlation between environmental metadata and product-service transactions. In another example, the IVER system may further develop the APA model to include consumer profile data associated with each of product-service transactions, providing another correlation data-point (i.e. environmental metadata, historical product-service transaction data, and consumer profile data).

Once developed, the IVER system may use the AP analysis model to capture current environmental metadata associated with the geographic region and consumer profile data associated with the subset of consumers and generate an AP Applicability (AFA) score for each product-service offering based at least in part on the captured data and the AP analysis model. The AFA score may be alpha-numeric (i.e. 0 to 10, or A to F), a descriptive expression (i.e. low, medium, or high), based on color (i.e. red, yellow, or green), or any other suitable scale that reflects a correlation between a product-service offering and the subset of consumers.

In this way, the IVER system may selectively recommend product-service offerings to the subset of consumers based on the AFA score. For example, the IVER system may be configured to recommend product-service offerings with medium-high and applicability scores (i.e. 6 to 10, A to C, medium or high, or yellow or green).

Development of an AP analysis model may be an iterative process. Environmental metadata, product-service transaction data, and consumer profile data may be continuously evaluated to progressively refine the AP analysis model. As more data becomes available, a continuously more accurate AP analysis model may be developed. In various examples, environmental metadata, product-service transaction data, and consumer profile data, as it is learned, is persisted, for example, in a data store, as stored data. Stored data may be continuously associated with one or more recommendations, such that a correlation between a current consumer profile and/or current environmental metadata within a geographic region may trigger delivery of a recommendation of a product-service offering.

In another example, the IVER system may generate a consumer analysis model for the purpose of generating a store-front of product-service offerings for presentation to a consumer. The consumer analysis model may be configured to dynamically generate a store-front (i.e. presented via a consumer portal of the IVER application) that presents a selection of product-service offerings from one or more APs, based on consumer profile data associated with the consumer. In one example, a consumer analysis model may be derived based on profile data of one consumer registered with the IVER system. In another example, a consumer analysis profile may be derived based on consumer profile data for a subset of consumers. The IVER system may cluster subsets of consumers together based on geographic areas that are frequently visited or a place of residence. Alternatively, or additionally, the IVER system may cluster subsets of consumers based on correlations within profile data, such as demographic data, categories of product interest, categories of service interest, or any combination thereof.

Moreover, the IVER system may selectively enable a consumer to create a store front that prioritizes a presentation of product-service offerings to the consumer via the consumer portal of their IVER application. In one example, the IVER system may enable a consumer to create a storefront based on a preferred product-service category (i.e. arts & entertainment, electronics, vehicle parts, and/or so forth) or individual product-service campaigns. In each instance, the IVER system retrieve, from a data store, product-serving offerings associated with one or more APs and further create a store front, based on the consumer selection.

In some examples, the store front presentation of product-service offerings may be further refined via a consumer analysis model that correlates a storefront selection of product-service offerings with historical product-service transaction data and profile data associated with the consumer.

The IVER system may generate the consumer analysis model using any combination of a record of historical product-service transaction data executed by the consumer, a record of product-service offerings viewed via an IVER application (i.e. consumer portal) by the consumer, profile data associated with the consumer, or the storefront selection of preferred categories/campaigns of product-services.

Once developed, the IVER system may use the consumer analysis model to capture current product-service offerings associated with one or more APs and generate a consumer-applicability (CA) score for each product-service offering based at least in part on the captured data and the consumer analysis model. The CA score may be alpha-numeric (i.e. 0 to 10, or A to F), a descriptive expression (i.e. low, medium, or high), based on color (i.e. red, yellow, or green), or any other suitable scale that reflects a correlation between a product-service offering and the consumer. In this way, the IVER system may selectively present product-service offerings to a consumer storefront based at least in part on the CA score.

Further, the term “techniques,” as used herein, may refer to system(s), method(s), computer-readable instruction(s), module(s), algorithms, hardware logic, and/or operation(s) as permitted by the context described above and through the document.

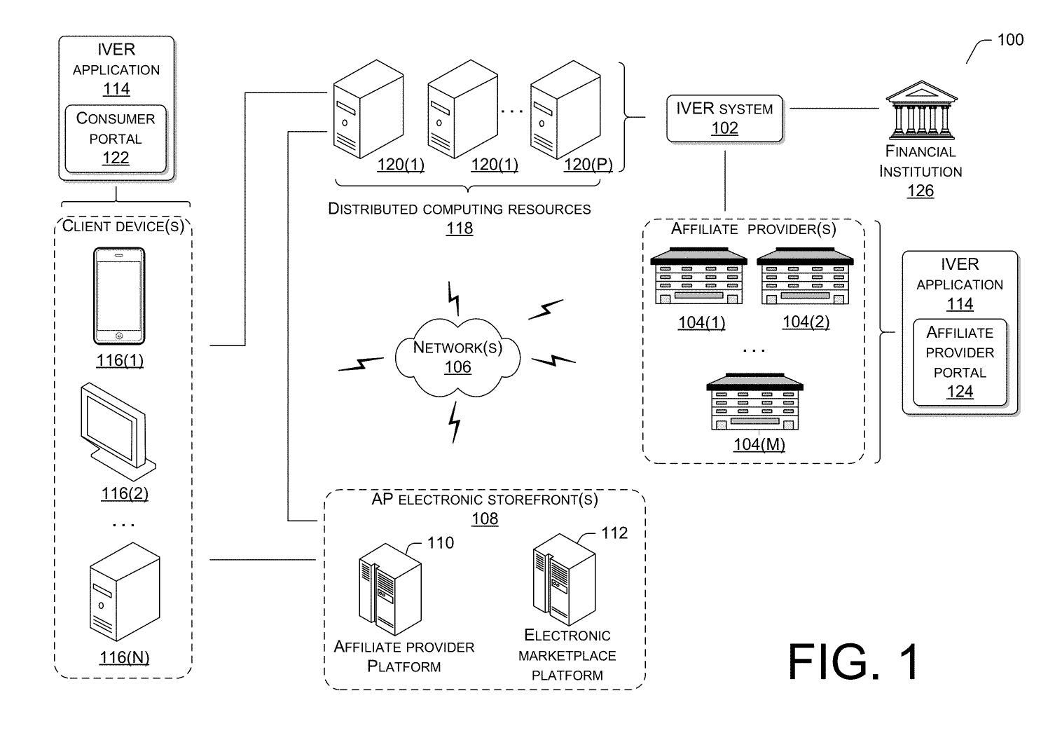

FIG. 1 illustrates an example architecture of an Integrated Value Exchange and Referral (IVER) system. In a non-limiting example, the IVER system 102 may interact with one or more AP(s) 104(1)-104(M) via one or more network(s) 106. The AP(s) 104(1)-104(M) may include a merchant, vendor, brand, or service provider that offers a product or service to consumers via one or more AP electronic storefront(s) 108. The AP electronic storefront(s) 108 may be associated with an affiliate provider platform 110 or an electronic marketplace platform 112. The AP electronic storefront(s) 108 associated an affiliate provider platform 110 may offer products or services that are exclusive to AP, such as AP(s) 104(1)-104(M), or product or services through brand websites. Alternatively, an AP electronic storefront(s) 108 associated with an electronic marketplace platform 112 may offer product or services from multiple merchants, sellers, brands, and other affiliate providers.

Particularly, the IVER system 102 may publish a listing of product-service offerings associated with the AP(s) 104(1)-104(M). The product-service offerings may be published via an IVER application 114 native on a client device 116. The IVER application 114 may be configured as a general platform or a white-label platform. A general platform of an IVER application 114 may present and inter-mingle product-service offerings from multiple AP(s) 104(1)-104(M). For example, a consumer may search for a product or service via the general platform of an IVER application 114. In doing so, the IVER system 102 may filter and aggregate a listing of substantially similar products or services from multiple affiliate providers. Further, the listing of substantially similar products or services may be sourced from AP electronic storefront(s) 108 (i.e. affiliate provider platform 110 and/or electronic marketplace platforms 112).

In contrast, a white-label platform of an IVER application 114 may present multiple product-service offerings that are associated with a subset of AP(s) 104(1)-104(M). In one example, the subset of AP(s) 104(1)-104(M) may include one affiliate provider. Any number of AP(s) 104(1)-104(M) is possible. In this example, a consumer may search for a product or service via a white-label platform of an IVER application 114. In doing so, the IVER system 102 may filter and aggregate a listing of substantially similar products or services from affiliate providers identified within the subset of AP(s) 104(1)-104(M).

In the illustrated example, a consumer may access a general platform or white-label platform of an IVER application 114 via one or more client device(s) 116(1)-116(N), collectively referred to as client device(s) 116. In this example, a consumer may perform a product-service search for a product-service via a user-interface associated with the IVER application 114 native to the client device 116. In doing so, the IVER system 102 may filter and aggregate tailored product-service offerings from AP electronic storefront(s) 108, and further publish a listing of the product-service offerings via the user interface of the IVER application 114 native on the client device 116. Each product-service offering may include a product-service link that re-directs a client device 116 from a presentation of the IVER application 114 to a presentation of an electronic storefront associated with the product-service offering. The product-service link may correspond to a selectable option that is embedded within a presentation of a product-service on the IVER application 114. The product-service link may permit a client device 116 to access an offer to purchase the product-service via an AP electronic storefront 108. In some examples, the product-service link may correspond to a Uniform Resource Locator (URL). In addition, a user interface of the client device 116 may permit consumers to share products and services via social media, email, text message and other digital methods by sharing their personal URL. It is noteworthy that each product-service link provides a unique and shareable association between the consumer and product-service offering. In one example, the product-service link may present the consumer with a benefit (i.e. reward, commission, or discount) that is unique to the consumer and independent of a presentation of the same product-service offering if navigated to directly from an AP electronic storefront 108 associated with the affiliate provider.

In the illustrated example, the IVER system 102 and AP(s) 104(1)-104(M) may exchange a data flow that includes registration data, product-service campaign data, and purchase event status. Registration data may correspond to registration of an AP, such as one of AP(s) 104(1)-104(M), with the IVER system 102 and may include at least profile data of AP, such as AP(s) 104(1)-104(M). Product-service campaign data may correspond to product or service offerings that an AP, such as one of AP(s) 104(1)-104(M), intends to present to consumers via the IVER system 102 and may include at least identifiers associated with the product or service offerings. Further, the purchase event status may indicate a status of an interaction (i.e. purchase event data) between a consumer and an electronic storefront, as the interaction relates to a product-service offering.

Additionally, the IVER system 102 may generate a purchase event for a product-service offering, in response to detecting, via an IVER application 114 native to a client device 116, a client selection to access a product-service offering at an AP electronic storefront 108. A purchase event may then be assigned a purchase event status, such as, a “pending,” “fulfilled,” “approved,” or “abandoned” status. A “pending” event status may indicate that a client has initiated a purchase event via an electronic storefront. A “fulfilled” event status may indicate that a client has provided consideration (i.e. payment) for the product-service, as stipulated within the product-service offering. An “approved” event status may indicate that a commission benefit is payable to an affiliate provider, and an “abandoned” event status may indicate that a client has not fulfilled a purchase event for a predetermined time interval.

Additionally, the IVER system 102 may interact with one or more AP electronic storefront(s) 108 to update and synchronize product-service offerings that are presented to consumers, via the IVER system 102. Particularly, the IVER system 102 may retrieve synchronization data that includes a product name, description, price, availability, and any other data pertinent to the product-service offering. The benefit of doing so ensures that consumers receive up to date product-service campaign data, via the IVER system 102. Further, the IVER system 102 may monitor product-service offerings on each of the AP electronic storefront(s) 108 on a continuous basis, at predetermined time intervals, or in response to a triggering event. The triggering event may correspond to an indication from an affiliate provider platform 110 or an electronic marketplace platform 112 that data for a product-service offering has been updated.

Further, synchronization data may also include data associated with purchase events at the AP electronic storefront(s) 108 that were initiated via an IVER application 114. In one example, the synchronization data may indicate a purchase event status as “pending,” “fulfilled,” “approved,” or “abandoned.”

In the illustrated example, the IVER system 102 may operate on one or more distributed computing resource(s) 118. The one or more distributed computing resource(s) 118 may include one or more computing device(s) 120(1)-120(P) that operate in a cluster or other configuration to share resources, balance load, increase performance, provide fail-over support or redundancy, or for other purposes. The one or more computing device(s) 120(1)-120(P) may include one or more interfaces to enable communications with other networked devices, such as the client device(s) 116(1)-116(N), via one or more network(s) 106. Further, the one or more network(s) 106 may include public networks such as the Internet, private networks such as an institutional and/or personal intranet, or some combination of private and public networks. The one or more network(s) 106 can also include any type of wired and/or wireless network, including but not limited to local area network (LANs), wide area networks (WANs), satellite networks, cable networks, Wi-Fi networks, Wi-Max networks, mobile communications networks (e.g. 3G, 4G, LTE and so forth), or any combination thereof.

Furthermore, the client device(s) 116(1)-116(N) may include any sort of electronic device, such as a cellular phone, a smart phone, a tablet computer, an electronic reader, a media player, a gaming device, a personal computer (PC), a laptop computer, a voice-controlled device, a computing device(s) that facilitate an augmented reality platform and/or a virtual reality platform etc. The client device(s) 116(1)-116(N) may have a subscriber identity module (SIM), such as an eSIM, to identify the client device(s) 116(1)-116(N) to a telecommunication service provider network (also preferred to herein as “telecommunication network”).

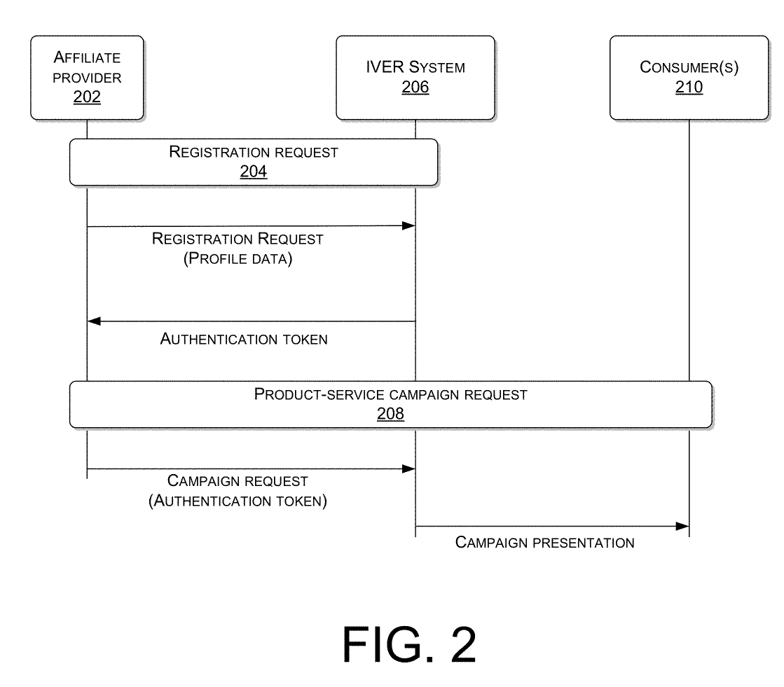

FIG. 2 illustrates a block diagram of an IVER system process for registering an Affiliate Provider (AP) with the IVER system and further generating a product-service campaign. In the illustrated example, the AP 202 may initiate a registration request 204 by transmitting profile data to the IVER system 206. In some examples, profile data may include an indication of whether the AP intends to present product-service campaigns via a general platform of a white-label platform of an IVER application. In doing so, the IVER system may generate and transmit an authentication token to the AP 202. The authentication may include an AP identifier that uniquely identifies the AP 202 to the IVER system 206. In one example, the AP identifier may further indicate whether the AP elected to present product-service campaigns via a general platform or a white-label platform of an IVER application. By default, the IVER system 206 may associated an AP with a general platform if the registration request 204 does not include an indication requesting a white-label platform.

Moreover, the AP 202 may further transmit a product-service campaign request 208 to the IVER system 206. The product-service campaign request 208 may include the authentication token associated with the AP, along with an indication that that the AP intends to present the product-service offering via a general platform or a white-label platform. The product-service campaign request may also include a product-service identifier that uniquely identifies the product-service associated with the product-service campaign request.

Moreover, the product-service campaign request may further include product-service offering data associated with each product-service offering, such as a title or headline of the product-service, a corresponding category and description, an availability, a purchase price, and a product-service link through which the product-service offering may be accessible to consumers for purchase via an AP electronic storefront.

In response to verifying an authenticity of the authentication token associated with the AP 202, the IVER system 206 may generate a product-service campaign, based at least in part on the product-service campaign request 208. In doing so, the IVER system 206 may present, or make available for presentation, the product-service campaign to consumer(s) 210 via consumer portal of an IVER application.

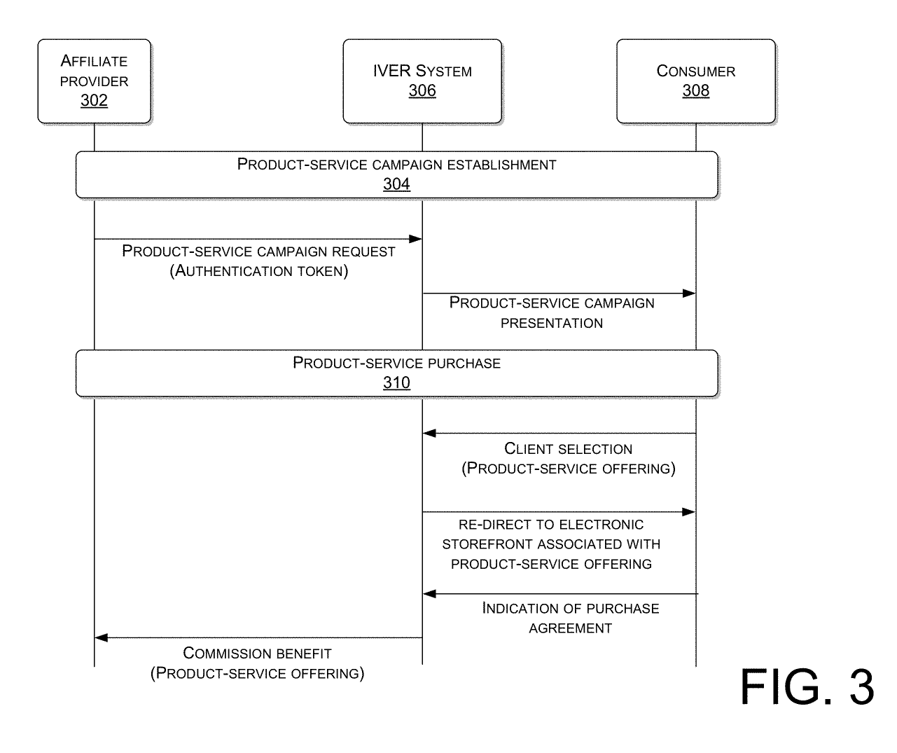

FIG. 3 illustrates a block diagram of an IVER system process for establishing a product-service campaign and further executing a purchase transaction of a product-service offering via an IVER application. In the illustrated example, an Affiliate Provider (AP) 302 may establish a product-service campaign 304 as earlier described with reference to FIG. 2. More specifically, the AP 302 may transmit a product-service campaign request to the IVER system 306 that includes at least an authentication token that uniquely identifies the AP 302 to the IVER system 306 and corresponding product-service offering data. In response to verifying an authenticity of the authentication token, the IVER system 306 may generate the product-service campaign, and further present, or make available for presentation, the product-service campaign to consumers, such as consumer 308 via consumer portal of an IVER application.

Moreover, the consumer 308 may access the product-service campaign via the consumer portal of an IVER application and select a product-service offering associated with the product-service campaign. It is noteworthy that that the product-service campaign may relate to a particular product or service, such as a “frame” or a “sporting good,” and the product-service offerings associated with the product-service campaign may relate to different offerings of the “frame” or the “sporting good.” Each offering may differ based on the AP, or the terms and conditions of the product-service offering (i.e. commission benefit, availability, price, discount, and/or so forth).

Further, the consumer 308 may elect to initiate a product-service purchase event 310 by selecting a product-service offering with the product-service campaign. In doing so, the IVER system 306 may cause the IVER application associated with the consumer 308 to redirect to an AP electronic storefront that includes an additional description of the “framing product” and further facilitates a purchase event. The IVER system 306 may further transmit a data packet to the AP electronic storefront that includes an AP identifier and a tracking data set, such as a tracking cookie, that is configured to cause the AP electronic storefront to transmit a value to the IVER system 306 in response to the consumer electing to purchase the product-service via the AP electronic storefront. In response to verifying that the consumer has completed the transaction to purchase the product-service offering (i.e. a paid event status), the IVER system 306 may record the purchase event, and further cause an account of the AP to reflect a pending or available commission benefit that will be available once the purchase event has been approved (i.e. an approved event status).

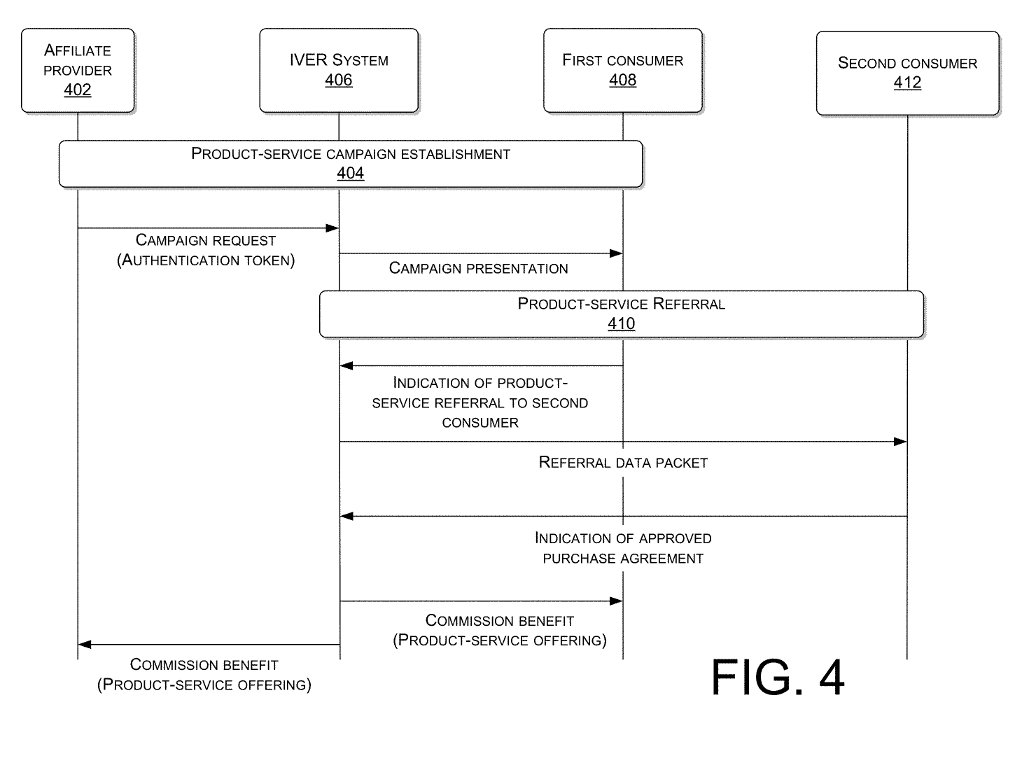

FIG. 4 illustrates a block diagram of an IVER system process for facilitating a first consumer referral of a product-service offering, and further executing a purchase agreement and payment of a commission benefit to the first consumer and Affiliate Provider (AP). In the illustrated example, an AP 402 may establish a product-service campaign 404 as earlier described with reference to FIG. 2. More specifically, the AP 402 may transmit a product-service campaign request to the IVER system 406 that includes at least an authentication token that uniquely identifies the AP 402 to the IVER system 406 and corresponding product-service offering data. In response to verifying an authenticity of the authentication token, the IVER system 406 may generate the product-service campaign, and further present, or make available for presentation, the product-service campaign to consumers, such as first consumer 408 via consumer portal of an IVER application.

In the illustrated example, the first consumer 408 may selectively initiate a product-service referral 410 of a product-service offering associated with the product-service campaign to a second consumer 412. In this example, the first consumer 408 may select an option to “share” or “refer” the product-service offering via a consumer portal of their IVER application. In doing so, the IVER application associated with a client device of the first consumer 408 may transmit an indication of the referral to the IVER system 406. The indication of the referral may include a configured product-service referral generated by the first consumer 408 at their IVER application, along with a selected communication medium by which the product-service offering may be delivered to the second consumer 412. The configured product-service referral may correspond to text data, video data, image data, audio data, or any combination thereof. Further, the communication medium may correspond to Short Message Service (SMS) message, a Multimedia Message Service (MMS) message, a Rich Communication Service (RCS) message, an electronic mail (e-mail) message, a voice message (i.e. voicemail), or any other known communication medium capable of transmitting and presenting multimedia content to a client device associated with the second consumer 412.

Moreover, the IVER system 406 may generate and deploy a referral data packet with the product-service offering to a second client device associated with the second consumer 412. The referral data packet may include an identifier that uniquely identifies the first consumer 408 to the IVER system 406, and further facilitates tracking progress of a transaction (i.e. purchase event) for the product-service offering by the second consumer 412. In this example, the referral data packet may also include another identifier that uniquely identifies the AP 402 that first presented the product-service offering via the IVER system 406 to the first consumer 408. In doing so, and in response to verifying that the second consumer 412 has completed a purchase transaction (i.e. a paid event status), the IVER system 406 may cause accounts of the first consumer 408 and AP 402 to reflect a pending commission benefit that will be available once the purchase event has been approved (i.e. an approved event status).

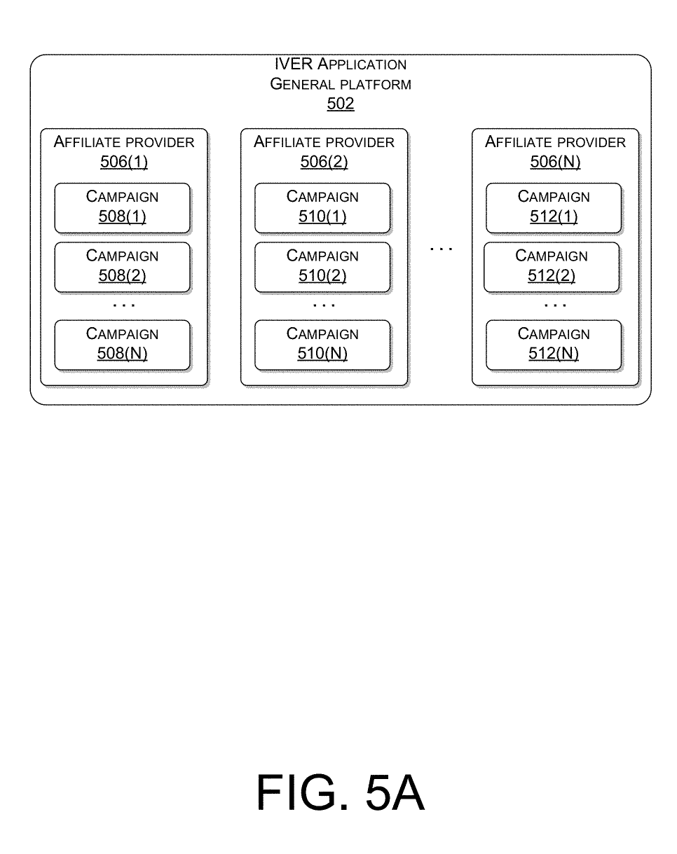

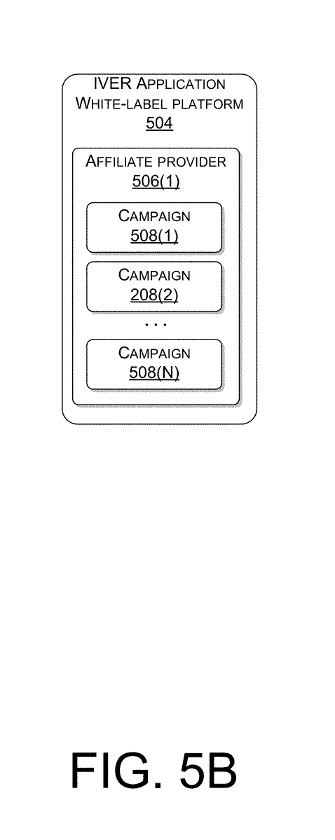

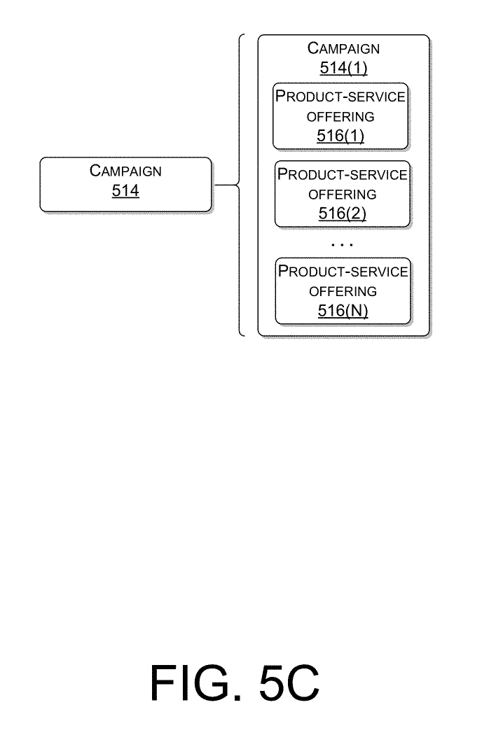

FIGS. 5A through to 5C illustrate a block diagram of a general platform of an IVER application 502 and a white-label platform of an IVER application 504. The general platform of an IVER application 502 and the white-label platform of an IVER application 504 may correspond to IVER application 114. Further, FIG. 5A illustrates a general platform of an IVER application 502 that is configured to present and inter-mingle multiple campaigns from multiple, affiliate provider(s) (APs) 506(1)-506(N). In the illustrated example, AP(s) 506(1)-506(N) may present individual product-service campaign(s) 508(1)-508(N), 510(1)-510(N), and 512(1)-512(N), respectively. Consumer(s) may access the general platform of an IVER application 502 via a consumer portal 122 of the general platform of an IVER application 502, as depicted in FIG. 1. Further, an AP, such as one of AP(s) 506(1)-506(N), may access the general platform of an IVER application 502 via an AP portal of an IVER application, such as the AP portal 124, as depicted in FIG. 1 with reference to IVER application 114.

FIG. 5B illustrates a white-label platform of an IVER application 504. The white-label platform of an IVER application 504 is configured to present multiple campaigns from a subset of affiliate provider(s). In the illustrated example, the subset of AP(s) may include AP 506(1). Further, the white-label platform of an IVER application 504 may present individual product-service campaign(s) 508(1)-508(N). Consumer(s) may access the white-label platform of an IVER application via a consumer portal 122 of the IVER application 114, as depicted in FIG. 1. Further, an AP, such as one of AP(s) 506(1)-506(N), may access the white-label platform of an IVER application 504 via an AP portal of an IVER application, such as the AP portal 124, as depicted in FIG. 1 with reference to IVER application 114.

FIG. 5C illustrates a block diagram of a typical, campaign 514(1). The typical, product-service campaign 514 may correspond to product-service campaign(s) 508(1)-508(N), 510(1)-510(N), or 512(1)-512(N), as presented in FIGS. 5A and 5B. Particularly, the product-service campaign 514 may include one or more product-service offerings 516(1)-516(N) from individual electronic storefront(s), each selectively tailored to persuade consumers to commit to a purchasing agreement or sharing an offering with friends, family or acquaintances.

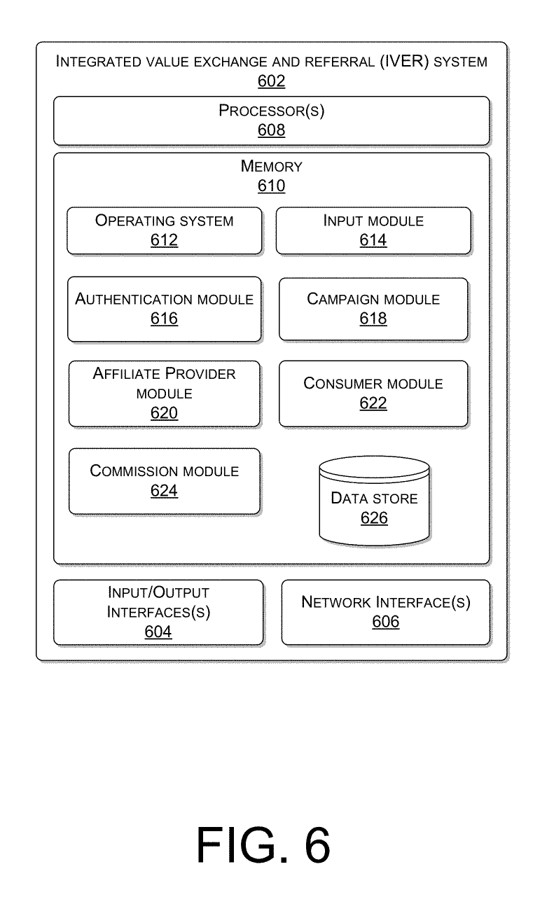

FIG. 6 illustrates an example architecture of an Integrated Value Exchange and Referral (IVER) system 602. The IVER system 602 may provide affiliate provider(s) with a capability to generate a product-service campaign that filters and aggregates product-service offerings from multiple electronic storefronts. In doing so, the IVER system 602 may further publish a listing of the product-service offerings on an IVER application configured as a general or white-label platform, and accessible via one or more client device(s).

In the illustrated example, the IVER system 602 may correspond to the IVER system 102. The IVER system 602 may include routines, program instructions, objects, and/or data structures that perform tasks or implement abstract data types. Further the IVER system 602 may include input/output interface(s) 604. The input/output interface(s) 604 may include any type of output interface known in the art, such as a display (e.g. a liquid crystal display), speakers, a vibrating mechanism, or a tactile feedback mechanism. Input/output interface(s) 604 also include ports for one or more peripheral devices, such as headphones, peripheral speakers, or a peripheral display. Further, the input/output interface(s) 604 may further include a camera, a microphone, a keyboard/keypad, or a touch-sensitive display. A keyboard/keypad may be a push button numerical dialing pad (such as on a typical telecommunication device), a multi-key keyboard (such as a conventional QWERTY keyboard), or one or more other types of keys or buttons, and may also include a joystick-like controller and/or designated navigation buttons, or the like. Further, the input/output interface(s) 604 may facilitate client and system interactions via an augmented reality platform, a virtual reality platform, a voice-controlled platform, or any combination thereof.

Additionally, the IVER system 602 may include network interface(s) 606. The network interface(s) 606 may include any sort of transceiver known in the art. For example, the network interface(s) 606 may include a radio transceiver that performs the function of transmitting and receiving radio frequency communications via an antenna. In addition, the network interface(s) 606 may also include a wireless communication transceiver and a near field antenna for communicating over unlicensed wireless Internet Protocol (IP) networks, such as local wireless data networks and personal area networks (e.g. Bluetooth or near field communication (NFC) networks). Further, the network interface(s) 606 may include wired communication components, such as an Ethernet port or a Universal Serial Bus (USB).

Further, the IVER system 602 may include one or more processor(s) 608 that are operably connected to memory 610. In at least one example, the one or more processor(s) 608 may be a central processing unit(s) (CPU), graphics processing unit(s) (GPU), a both a CPU and GPU, or any other sort of processing unit(s). Each of the one or more processor(s) 608 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution. The one or more processor(s) 608 may also be responsible for executing all computer applications stored in the memory, which can be associated with common types of volatile (RAM) and/or nonvolatile (ROM) memory.

In some examples, memory 610 may include system memory, which may be volatile (such as RAM), non-volatile (such as ROM, flash memory, etc.) or some combination of the two. The memory may also include additional data storage devices (removable ad/or non-removable) such as, for example, magnetic disks, optical disks, or tape.

The memory 610 may further include non-transitory computer-readable media, such as volatile and nonvolatile, removable and non-removable media implemented in any method or technology for storage of information, such as computer readable instructions, data structures, program modules, or other data. System memory, removable storage and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

In the illustrated example, the memory 610 may include an operating system 612, an input module 614, an authentication module 616, a campaign module 618, an AP module 620, a consumer module 622, a commission module 624, and a data store 626. The operating system 612 may be used to implement the input module 614, the authentication module 616, the campaign module 618, the AP module 620, the consumer module 622, the commission module 624, and the data store 626. The operating system 612 may be any operating system capable of managing computer hardware and software resources.

The input module 614 may be configured to receive data from an Affiliate Provider (AP) or a consumer via their respective IVER application (i.e. AP portal and consumer portal of an IVER application). In one example, the input module 614 may receive a registration request and product-service campaign request from an AP portal of an IVER application associated with an AP. Further, the input module 614 may receive a request to initiate a purchase event from a consumer portal of an IVER application associated with a consumer. In some examples, the input module 614 may receive signals from AP electronic storefront associated with a tracking data set that is configured to monitor progress of a purchase event initiated by a consumer at an AP electronic storefront. Further, the input module 614 may also retrieve environmental metadata that is used to generate an AP analysis model, and a consumer selection to create a consumer storefront that prioritizes a presentation of preferred product-service offerings.

The authentication module 616 is configured to generate and verify an authenticity of an authentication token associated with an AP and consumer. In some examples, the authentication module 616 may generate identifiers that uniquely identify an AP and a consumer to the IVER system. In some examples, the authentication module 616 may further generate a campaign identifier that uniquely identifiers whether the AP elects to present product-service campaigns via a general platform or a white-label platform of an IVER application.

The campaign module 618 may be configured to generate one or more product-service campaigns. In one example, the campaign module 618 may generate product-service campaigns based at least in part on product-service campaign requests associated with an AP. The campaign module 618 may retrieve product-service offering data associated with each product-service campaign from the data store of the IVER system 602 or via AP electronic storefronts associated with an AP. In another example, the campaign module 618 may employ one or more trained machine learning algorithms to analyze performance metrics associated with each product-service campaign over a predetermined time interval, and in doing so, further generate one or more product-service campaigns based at least in part on the performance metrics. For example, the campaign module 618 may generate one or more product-service campaigns based on performance metrics, such as, but are not limited to, most-shared product-service offerings, most-clicked product-service offerings, most-purchased product-service offerings, highest-commission product-service offerings, or any combination thereof.

The campaign module 618 may selectively normalize performance metrics to account for product-service campaigns that have been active for different periods of time. The campaign module 618 may further synchronize product-service offering data (i.e. a title or headline of the product-service, a corresponding category and description, an availability, a purchase price, and a product-service link through which the product-service offering may be accessible) as presented via the consumer portal, with product-service offering data that resides at the AP electronic storefront (i.e. AP platform or electronic marketplace platform). The IVER system may synchronize product-service offering data continuously, on a predetermined schedule, or in response to a triggering event. The campaign module 618 may also dynamically update existing product-service campaigns, or create new product-service campaigns, to reflect a consumer's current search trends and search terms.

The AP module 620 may be configured to generate the consumer portal interface for a general platform of an IVER application and a white-label platform of an IVER application. The AP module 620 is further configured to monitor and analyze product-service campaigns associated with an AP, and further provide one or more recommendations to an AP. In some examples, the AP module 620 may use one or more trained machine learning algorithms to generate the AP analysis model using any combination of historical product-service transaction data, consumer profile data, and environmental metadata. The recommendations may relate to identifying a subset of consumers that may be likely to initiate or complete a purchase transaction for a particular product-service offering, identifying particular product-service offerings that may appeal to the subset of consumers, or better tailoring aspects of product-service offerings to appeal to the subset of consumers.

The consumer module 622 may be configured to generate a consumer storefront at a consumer portal of an IVER application that prioritizes a presentation of consumer-preferred product-service offerings. The consumer module 622 may monitor, facilitate, and analyze consumer interactions with a consumer portal of an IVER application. For example, the consumer module 622 may facilitate a first consumer referring a product-service offering to a second consumer. The consumer module 622 may also employ one or more machine learning algorithms to generate a consumer analysis model associated with the consumer. The consumer analysis model may be based on any combination of a record of historical product-service transaction data executed by the consumer, a record of product-service offerings viewed via an IVER application (i.e. consumer portal) by the consumer, profile data associated with the consumer, or the consumer storefront selection of preferred categories/campaigns of product-services. The consumer module 622 may use the consumer analysis model to generate the consumer storefront that prioritizes a presentation of consumer-preferred product-service offerings.

The commission module 624 may be configured to monitor progress of a purchase event via tracking data packets at an AP electronic storefront, and a referred consumer. The commission module 624 may monitor and designate a purchase event status as being one of “pending,” “abandoned,” “paid,” or “approved.”

In one example, the commission module 624 may track the progress of a purchase event initiated by a consumer via a consumer portal of an IVER application. More specifically, the commission module 624 may generate and deploy a data packet to the AP electronic storefront associated with the purchase event. The data packet may include an AP identifier and a tracking data set, such as a tracking cookie, that is configured to cause the AP electronic storefront to transmit a value to the commission module 624 in response to the consumer electing to purchase the product-service via the AP electronic storefront. In response to verifying that the consumer has completed the transaction to purchase the product-service offering (i.e. a paid event status), the commission module 624 may record the purchase event, and further cause an account of the AP to reflect a pending or available commission benefit that will be available once the purchase event has been approved (i.e. an approved event status).

In another example, the commission module 624 may track the progress of a purchase event that is the result for a first consumer referral to a second consumer. For example, in response to an indication from the consumer module 622, that a first consumer referred a product-service offering to a second consumer, the commission module 624 may generate and deploy a referral data packet with the product-service offering to a second client device associated with the second consumer. The referral data packet may include an identifier that uniquely identifies the first consumer to the IVER system, and further facilitates tracking progress of a transaction (i.e. purchase event) for the product-service offering by the second consumer. In this example, the referral data packet may also include another identifier that uniquely identifies the AP that first presented the product-service offering to the first consumer. In doing so, and in response to verifying that the second consumer has completed a purchase transaction (i.e. a paid event status), the commission module 624 may cause accounts of the first consumer and AP to reflect a pending commission benefit that will be available once the purchase event has been approved (i.e. an approved event status).

The data store 626 may include historical data associated with APs and consumers registered with the IVER system. For example, the data store 626 may include a record of historical product-service transaction data executed by each consumer, a record of product-service offerings viewed via an IVER application (i.e. consumer portal) by each consumer, profile data associated with each consumer. Further the data store 626 may also include historical product-service transaction data, consumer profile data, and environmental metadata associated with an AP. Further, the data store 626 may include current and historical iterations of an AP analysis model and consumer analysis model, along with corresponding recommendations.

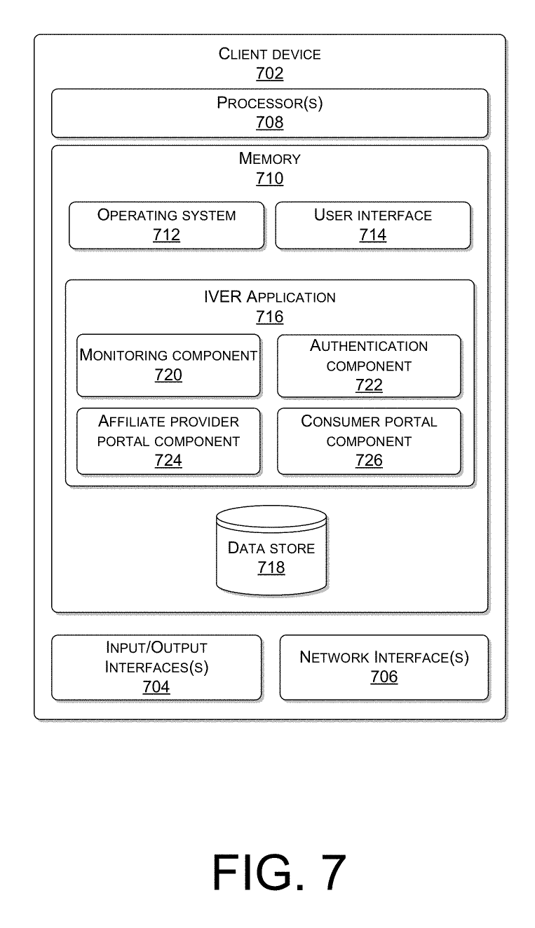

FIG. 7 illustrates an example architecture of a client device that is configured to execute an IVER application associated with the IVER system. The client device 702 may include routines, program instructions, objects, and/or data structures that perform tasks or implement abstract data types. Further the client device 702 may include input/output interface(s) 704 and network interface(s) 706. The input/output interface(s) 704 may correspond to input/output interface(s) 604, and the network interface(s) 706 may correspond to network interface(s) 606. Moreover, the client device 702 may include one or more processors(s) 708 that are operably connected to memory 710. The one or more processor(s) 708 may correspond to the one or more processor(s) 608, and the memory 710 may correspond to the memory 610.

In the illustrated example, the memory 710 may include an operating system 712, a user interface 714, an IVER application 716, and a data store 718. The authentication component 722 may be configured to interact with the IVER system 602, and further authenticate a user as an AP or a consumer based on their authentication credentials. Further, the user interface 714 may be configured to present a AP portal of the IVER application 716 or a consumer portal of the IVER application 716, based at least in part on the authentication credentials associated with the user of the client device 702. For example, if the user is authenticated as an AP, the user interface 714 may be configured to present an AP portal of the IVER application 716. In contrast, if the user is authenticated as a consumer, the user interface 714 may be configured to present a consumer portal of the IVER application 716.

The IVER application 716 may further include a monitoring component 720, an authentication component 722, an AP portal component 724, and a consumer portal component 726. The monitoring component 720 may monitor user (i.e. AP and consumer) interactions with the IVER application. In some examples, the monitoring component 720 may further capture environmental metadata associated with an AP, for further use by an IVER system 602 to generate an AP analysis model.

The AP portal component 724 may be configured to provide a user authenticated as an AP with access privileges to create, modify, or remove product-service campaigns on the IVER system 602. Further, the AP portal component 724 may also interact with the commission module 624 of the IVER system 602 to provide an AP with a purchase event status and a corresponding commission benefit status.

The consumer portal component 726 may be configured to provide a user authenticated as a consumer with access privileges to interact with product-service campaigns offered by an AP, and further create a consumer storefront within the IVER application of consumer-preferred product-service offerings. Further, the consumer portal component 726 may also interact with the commission module 624 of the IVER system 602 to provide a consumer with a purchase event status and a corresponding commission benefit status associated with the product-service offerings that were referred to a second consumer.

The data store 718 may store data captured via the monitoring component 720, authentication credentials associated with a user (i.e. AP and consumer), along with any other pertinent data associated with operation of the IVER application 716 on the client device 702. In some examples, the data store 718 may correspond, in whole or in part, to the data store 626.

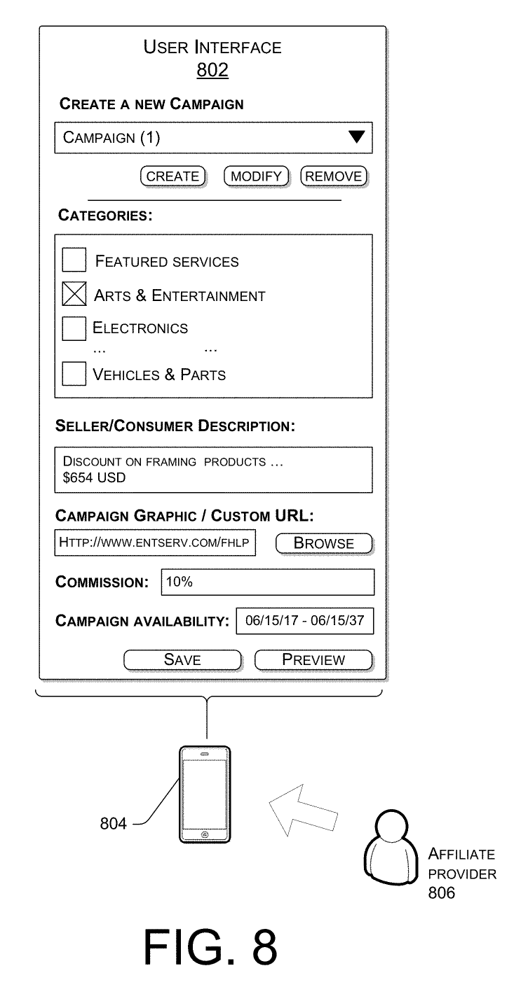

FIG. 8 illustrates a user interface of an IVER application that facilitates an Affiliate Provider (AP) creating, modify, or remove a product-service campaign associated with the IVER system. More specifically, the user interface 802 corresponds to an AP portal of the IVER application that presents one or more selectable options to establish, monitor, update, or remove a presentation of one or more product-service campaign(s) via the IVER system. The AP portal of the IVER application may be native to the client device 804 of the AP 806 or may be accessible via a web-based portal that is communicatively connected to the IVER system.

In the illustrated example, the user interface 802 presents selectable options for an AP 806 to create, modify or remove a product-service campaign. The user interface 802 further presents one or more categories to associate with the product-service campaign, a text field to include a seller/consumer description, a text field to include a URL through which a custom graphic may be associated with the product-service campaign. The user interface 802 further presents additional text fields for an AP 806 to input a commission benefit and a data range for availability of the product-service campaign.

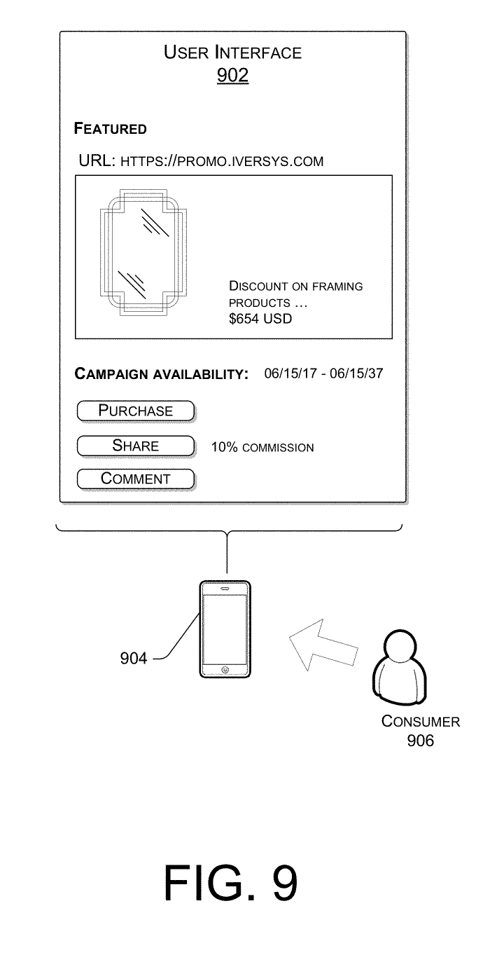

FIG. 9 illustrates a user interface of an IVER application that presents a consumer with a product-service offering associated with a product-service campaign. More specifically, the user interface 902 corresponds to a consumer portal of the IVER application that presents a product-service offering. The consumer portal of the IVER application may be native to the client device 904 of the consumer 906 or may be accessible via a web-based portal that is communicatively connected to the IVER system.

In the illustrated example, the user interface 902 presents a “framing product,” and one or more selectable options to purchase, share, or comment on the product-service offering. It is noteworthy that the consumer 906 may have been earlier presented with one or more product-service offerings related to the product-service campaign for the “framing product,” and in doing so, selected a particular product-service offering within the consumer portal of the IVER application. The selectable options include “purchase” “share” or “comment” on the product-service offering. In the event that the consumer 906 selects the “purchase” option, the user interface of the IVER application may be redirected to an AP electronic storefront that includes an additional description of the “framing product” and further facilitates a purchase event. In the event that the consumer 906 selects the “share” option, the user interface 902 of the IVER application may further prompt the consumer 906 to configure a product-service referral to another consumer (i.e. referred consumer). The product-service referral may include the form of the product-service referral (i.e. text data, video data, image data, audio data, or any combination thereof) and an identifier associated with the referred consumer.

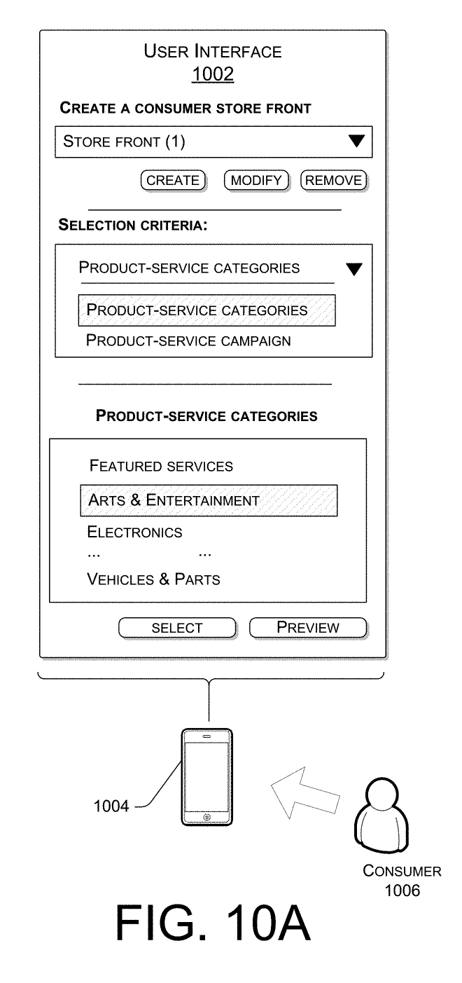

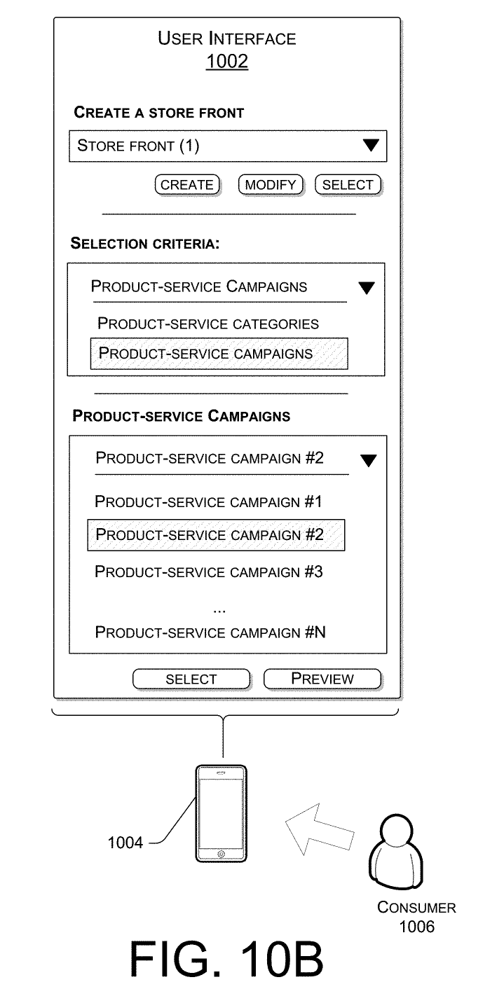

FIGS. 10A and 10B illustrate exemplary user interfaces of an IVER application for creating a consumer storefront of consumer-preferred product-service offerings. FIG. 10A illustrates a user interface 1002 for generating a consumer storefront based on product-service categories. More specifically, the user interface 1002 corresponds to a consumer portal of the IVER application that facilitates generating a consumer storefront. The consumer storefront is configured to present product-service campaigns, and their respective product-service offerings, to consumers via the consumer portal of an IVER application. The consumer portal of the IVER application may be native to the client device 1004 of the consumer 1006 or may be accessible via a web-based portal that is communicatively connected to the IVER system. FIG. 10A further presents selectable options for the consumer 1006 to create, modify, or remove a consumer storefront. The user interface 1002 further presents one or more selection criteria to create or modify a consumer storefront, namely product-service categories and product-service campaign. FIG. 10A further illustrates an exemplary selection to generate a consumer storefront based on product-service categories. In this example, the user interface 1002 may further present a second set of options of product-service categories, such as but not limited to, “featured services,” arts and entertainment.” The user interface 1002 also presents selectable options for the consumer 1006 to select one or more product-service categories and further preview a consumer storefront based on the selection.

Moreover, FIG. 10B illustrates an exemplary user interface to generate a consumer storefront based on product-service campaigns. In this example, the user interface 1002 may further present a second set of options of product-service campaigns, such as but not limited to, “product-service campaign #1,” “product-service campaign #2,” “product-service campaign #3,” and “product-service campaign #N.” The user interface 1002 also presents selectable options for the consumer 1006 to select one or more product-service campaigns and further preview a consumer storefront based on the selection.

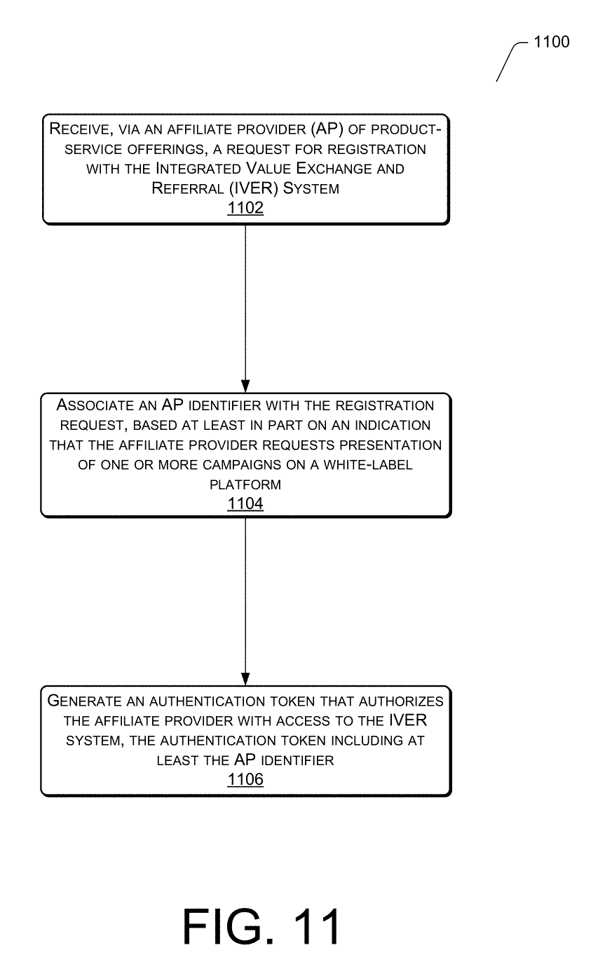

FIGS. 11 through 19 present processes 1100 through 1900 that relate to operations of the Integrated Value Exchange Referral System. Each of processes 1100 through 1900 illustrate a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 1100 through 1900 are described with reference to the computing environment 100 of FIG. 1.

FIG. 11 illustrates an IVER system process for processing a registration request with the IVER system. The registration request be associated an affiliate provider (AP) who intends to present product-service offerings to consumers via the IVER system. In one example, an AP may selectively register with the IVER system to present product-service campaigns via a white-label platform or a general platform. The white-label platform may allow an AP to customize the look and feel of the user interface of an IVER application (i.e. consumer portal of the IVER application accessible to consumers), while also filtering out competing APs that offer substantially similar products and services. In contrast, a general platform may present and inter-mingle product-service campaign(s) from multiple APs.

At 1102, the IVER system may receive, from an AP, a request to register with the IVER system. The registration request may include profile data associated with the AP and product-service offering data. In some examples, product-service offering data may include product-service identifiers associated with individual product-service offerings that the AP intends to present to consumers via the IVER system. The registration request may further include an indication that the AP intends to present one or more product-service campaigns via a general platform or a white-label platform.

At 1104, the IVER system may associate an AP identifier with the registration request. The AP identifier may uniquely identify the AP to the IVER system. In one example, the AP identifier may further indicate whether the AP elected to present product-service campaigns via a general platform or a white-label platform of an IVER application. By default, the IVER system may associated an AP with a general platform if the registration request does not include an indication requesting a white-label platform. In another example, the IVER system may associate a campaign identifier with the registration request. The campaign request may uniquely identify whether the AP elected to present product-service campaigns via a general platform or a white-label platform of an IVER application.

At 1106, the IVER system may generate an authentication token that authorizes the AP to access the IVER system. The authentication token may include at least the AP identifier, and in some cases, a campaign identifier. Use of the authentication token may ensure that product-service campaigns associated with an AP are appropriately directed to one of the general platform or a white-label platform, based on their initial registration request. Thus, the authentication token is integrated as an authorization header in each Application Programming Interface (API) call within the IVER system.

In various examples, an AP may register with the IVER system to present product-service campaigns via a general platform and a white-label platform. In this instance, the IVER system may generate separate authentication tokens that each associate the AP to one of the general platform and white-label platform. Alternatively, the IVER system may generate a single authentication token that associates the AP with the general platform and white-label platform, meaning that the AP is authorized to selectively present product-service campaigns on the general platform, white-label platform, or both.

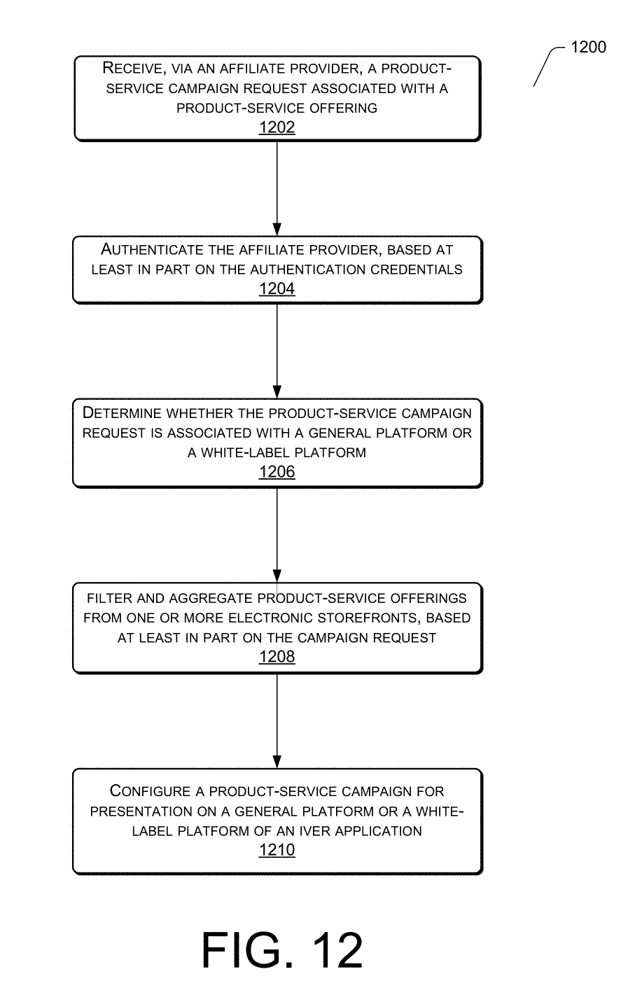

FIG. 12 illustrates an IVER system process for generating a product-service campaign for presentation on a user interface of an IVER application. The IVER application may be accessible via a client device of a consumer, whereby the consumer may access product-service campaigns via a dedicated consumer portal of the IVER application. In some examples, the IVER application may be native to a client device of the consumer, or accessible using a Uniform Resource Locator (URL) via the client device.

At 1202, the IVER system may receive, via an AP, a product-service campaign request associated with a product-service offering. The AP may submit the product-service campaign request via an AP portal of an IVER application that is accessible via a client device of the AP. The product-service campaign request may include authentication credentials associated with the AP, along with an indication that that the AP intends to present the product-service offering via a general platform or a white-label platform. The product-service campaign request may also include a product-service identifier that uniquely identifies the product-service associated with the product-service campaign request.

Moreover, the product-service campaign request may further include product-service offering data associated with each product-service offering, such as a title or headline of the product-service, a corresponding category and description, an availability, a purchase price, and a product-service link through which the product-service offering may be accessible to consumers for purchase via an AP electronic storefront.

At 1204, the IVER system may authenticate an identity of the AP, based at least in part on the authentication credentials. In some examples, the IVER system may authenticate an identity of the AP by comparing the AP identifier that is part of the authentication token with stored authentication records.

At 1206, in response to authenticating an identity of the AP, the IVER system may further determine whether the AP intends to present the product-service campaigns via a general platform or a white-label platform. In one example, the AP identifier may indicate that the AP intends to present the product-service offerings via a general platform a white-label platform. In another example, a campaign identifier may accompany the AP identifier, and further indicate the same. A null-value with regards to a general platform or white-label platform may indicate a default selection of general platform.

At 1208, the IVER system may filter and aggregate, from one or more AP electronic storefronts(s), a plurality of product-service offerings, based at least in part on the product-service campaign request. In one example, the product-service offerings may be stored within a data store of the IVER system. In a second example, the IVER system may generate the product-service offerings based on the product-service offering data that is included with the product-service campaign request. In a third example, the IVER system may search and retrieve the product-service offerings from multiple AP electronic storefronts (i.e. AP platforms and electronic marketplaces). Since each AP electronic storefront is likely to tailor a same product-service offering in a different way (i.e. look and feel of presentation, commission benefit, discount etc.), consumers may benefit from having access to each available product-service offering.

At 1210, the IVER system may configure a product-service campaign for presentation on a general platform or a white-label platform of an IVER application. In this example, a consumer may search for and access the product-service campaign via a consumer portal of an IVER application that is configured for the respective general platform or the white-label platform.

Further, each product-service offering may include a selectable option to access an offer to purchase the product-service via an electronic storefront associated with the AP. In some examples, the selectable option may include a Uniform Resource Location (URL).

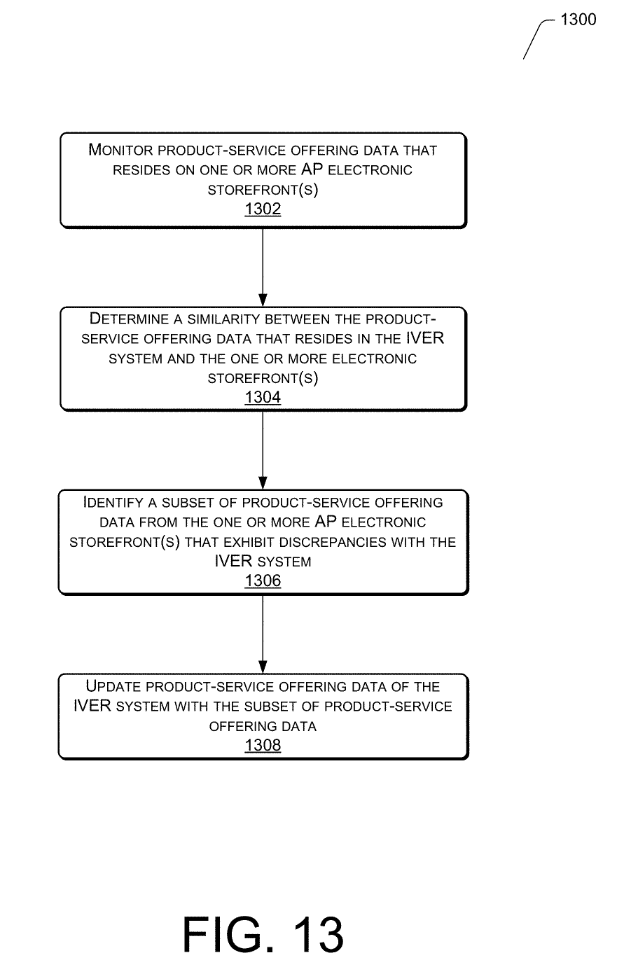

FIG. 13 illustrates an IVER system process for synchronizing product-service offering data stored within the IVER system, with product-service offering data that resides on one more AP electronic storefronts (i.e. AP platforms and electronic marketplaces). An AP platform may be a platform through which an AP offers an exclusive selection of product-service offerings, such as a website exclusively associated with the AP. In contrast, an electronic marketplace platform may be a non-exclusive platform through which multiple APs offer product-service offerings.

Further, the product-service offering data may include a product or service name, description, price, availability, and any other pertinent data that may be presented to a consumer via an IVER Application.

At 1302, the IVER system may monitor product-service offering data that resides on one or more AP electronic storefronts, the product-service offering data being associated with a product-service offering that is part of an AP's product-service campaign. The IVER system may monitor product-service offering data on a continuous basis, at predetermined time intervals, or in response to a triggering event. In some examples, the triggering event may correspond to an indication from an AP electronic storefront that product-service offering data has been created, updated, or deleted.

At 1304, the IVER system may determine a similarity between the product-service offering data that resides in a campaign data-store of the IVER system, and the product-service offering data that resides on the one or more AP electronic storefront(s). The IVER system may be configured to detect changes in pertinent product-service data including, a product name, description, price, or availability.

At 1306, the IVER system may identify a subset of product-service offering data from the one or more AP electronic storefront(s), that exhibit discrepancies with IVER system. The discrepancies may relate to any one of a product or service name, description, price, availability, and any other pertinent data that may be presented to a consumer via an IVER Application.

At 1308, the IVER system may update the product-service offering data of the IVER system with the subset of product-service offering data from the AP electronic storefront(s). In doing so, the IVER system may retain and present real-time product-service offering data to consumers via a consumer portal of their respective IVER applications.

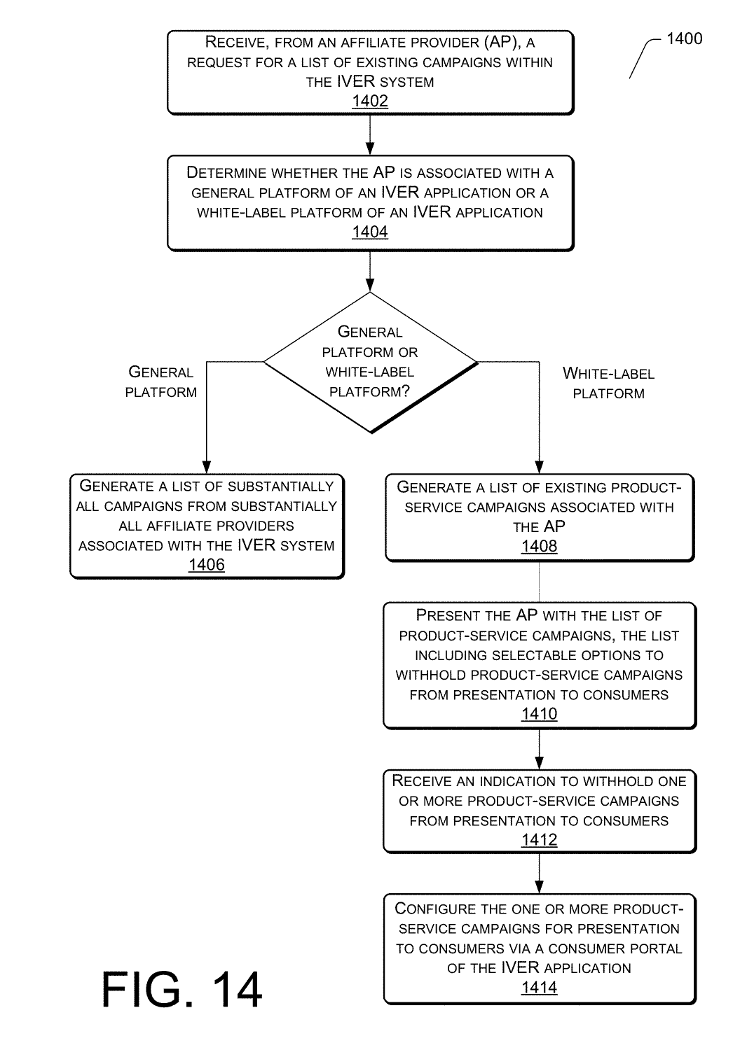

FIG. 14 illustrates an IVER system process for generating a list of AP product-service campaigns that are intended for or are currently being presented to consumers via consumer portal of an IVER application. Each product-service campaign may include one or more product-service offerings that are presented at one or more AP electronic storefront(s). For example, one product-service campaign may relate to a particular sporting merchandise, such as a baseball bat or an Australian Rules football. In this example, the product-service campaign may include multiple product-service offerings from different AP electronic storefront(s) (i.e. AP platform or electronic marketplace) that offer the baseball bat or Australian Rules football. The IVER may customize the list of product-service campaigns based on whether the product-service campaigns are presented via a white-platform or general platform of an IVER application.

At 1402, the IVER system may receive, from an AP via an AP portal of an IVER application, a request for a list of product-service campaigns that are intended for or are currently being presented to consumers via a consumer portal of an IVER application. In a non-limiting example, the request may be associated with product-service campaigns presented via a general platform of an IVER application, whereby the list of product-service campaigns may correspond to substantially all product-service campaigns related to the request from substantially all APs associated with the IVER system. In another non-limiting example, the request may be associated with product-service campaigns presented via a white-label platform of an IVER application, whereby the list of product-service campaigns may correspond to substantially all product-service campaigns related to the request from the white-label AP.

At 1404, the IVER system may determine whether the request is associated with a general platform or a white-label platform, based at least in part on authentication credentials of the AP. For example, the authentication credentials of the AP may include an AP identifier that indicates whether the AP intends to present product-service campaigns via a general platform or a white-label platform. Alternatively, a campaign identifier may accompany the AP identifier, and further indicate the same.

At 1406, the IVER system may determine that the request is associated with a presentation of product-service campaigns on a general platform of an IVER application. In doing so, the IVER system may generate a list of product-service campaigns that accounts for substantially all product-service campaigns related to the request from substantially all APs associated with the IVER system.

At 1408, the IVER system may determine that the request is associated with a presentation of product-service campaigns on a white-label platform of an IVER application. In doing so, the IVER system may generate a list of product-service campaigns for substantially all product-service campaigns related to the request from the white-label AP.

At 1410, the IVER system may present the AP with the list of product-service campaigns relates to the request that are associated with the white-label AP. The IVER system may further present one or more selectable options to withhold or present, each of the product-service campaigns to consumers via a consumer portal of an IVER application. In other words, an AP that presented product-service campaign(s) via a white-label platform may elect to present or withhold one or more product-service campaigns from consumers.

At 1412, the IVER system may receive, from a client device or web-based interface associated with the AP, an indication to withhold one or more product-service campaigns from presentation to consumers via a consumer portal of an IVER application.

At 1414, the IVER system may remove the one or more product-service campaigns from presentation to consumers via a consumer portal of the white-label platform of an IVER application. It is noteworthy that presentation of product-service campaigns that are withheld from presentation on a white-label platform, may be optionally withheld from presentation on a general platform of an IVER application.

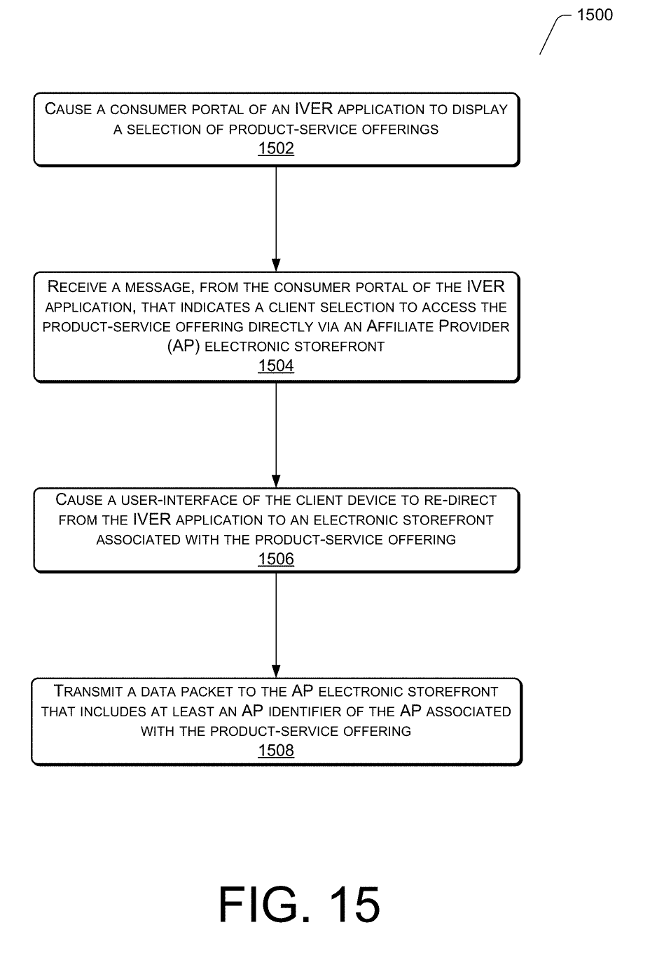

FIG. 15 illustrates an IVER system process that facilitates a tracking of purchase event initiated by a consumer via a consumer portal of an IVER application. In some example, a consumer may be redirected from a consumer portal of an IVER application to an AP electronic storefront, based on a consumer selection within the consumer portal. The consumer selection may be to view an additional description associated with a product-service offering or complete a corresponding transaction.

At 1502, the IVER system may cause a consumer portal of an IVER application, accessible via client device of a consumer, to display a selection of product-service offerings. Each product-service offering may include a product name, description, availability, purchase price, and a selectable option to access the product-service offering directly via an AP electronic storefront (i.e. a URL). The AP electronic storefront may correspond to an AP platform or an electronic marketplace platform. An AP platform may be a platform through which an AP offers an exclusive selection of product-service offerings, such as a website exclusively associated with the AP. In contrast, an electronic marketplace platform may be a non-exclusive platform through which multiple APs offer product-service offerings.

At 1504, the IVER system may receive a message, from the consumer portal of the IVER application, that indicates a client selection to access a product-service offering directly via an AP electronic storefront. In various examples, the client selection may correspond to selection of a URL associated with the product-service offering.

At 1506, the IVER system may cause the user interface of the IVER application to redirect the consumer to the product-service offering at the AP electronic storefront. In some examples, a display of the AP electronic storefront may be presented, inset within the consumer portal of the IVER application. In other examples, the IVER system may cause the user-interface of the client device to replace the display of the consumer portal of the IVER application with a display of the AP electronic storefront.

At 1508, the IVER system may transmit a data packet to the AP electronic storefront that includes an AP identifier that uniquely identifies the AP to the IVER system. The AP identifier may be used to track progress of a transaction (i.e. purchase event) for the product-service offering at the AP electronic storefront.

In some examples, the data packet may include a tracking data set, such as a tracking cookie, that is configured to cause the AP electronic storefront to transmit a value to the IVER system in response to a client electing to purchase the product-service via the electronic storefront. In response to verifying that a consumer has completed the transaction to purchase the product-service offering (i.e. a paid event status), the IVER system may record the purchase event, and further cause an account of the AP to reflect a pending or available commission benefit that will be available once the purchase event has been approved (i.e. an approved event status).

Alternatively, the tracking cookie may be configured to return a value to the IVER system in response to a status-update request, or ping, from the IVER system. For example, the IVER system may periodically ping a tracking data set. In doing so, the tracking data set may return a value to the IVER system that indicates a “pending” or “paid” event status.

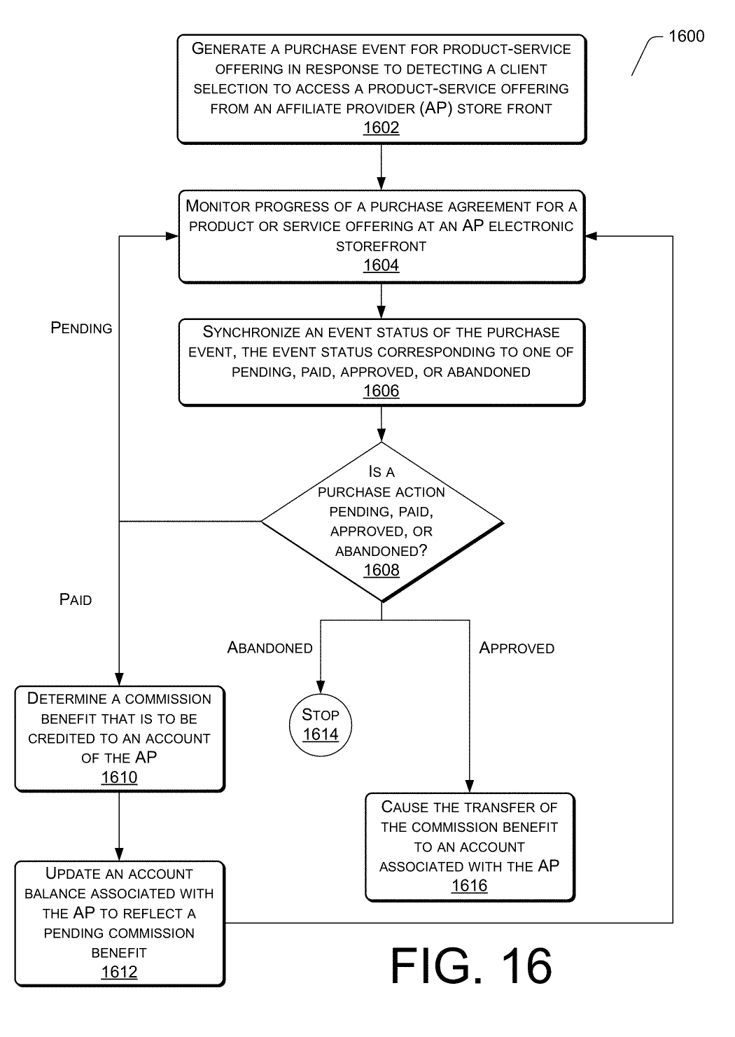

FIG. 16 illustrates an IVER system process that monitors and synchronizes product-service offering data associated with purchase events initiated via a consumer portal of an IVER application. In some examples, the IVER system may monitor AP electronic storefronts associated with APs to detect changes in pertinent product-service data including, a product name, description, price, or availability. In doing so, the IVER system may determine whether a purchase event remains pending, has been abandoned by a client, or has been paid by the client at the AP electronic storefront. In some examples, the IVER system may further assign an approved event status, which indicates that a commission benefit is payable to an AP associated with the product-service offering.

At 1602, the IVER system may generate a purchase event for a product-service offering in response to detecting, via a consumer portal of an IVER application, a client selection to access a product-service offering directly at an AP electronic storefront.

In one example, a purchase event may include data such as an event status, a product-service offering identifier and a corresponding an AP identifier associated with the AP. The event status may indicate whether a purchase event is presently “pending,” “paid,” “approved,” or abandoned.”

The purchase event may be generated at the same time, or substantially the same time, that a client device is re-directed from the consumer portal of an IVER application to an AP electronic storefront. The AP electronic storefront may correspond to an AP platform or an electronic marketplace platform.

At 1604, the IVER system may monitor progress of a purchase event at the AP electronic storefront by transmitting a tracking data packet to the AP electronic storefront. The IVER system may transmit the tracking data packet at the same time, or substantially the same time, as generating the purchase event.

The IVER system may ping the tracking data packet at periodic intervals that adhere to a predetermined schedule. For example, the IVER system may initiate a ping every hour, six hours, 24 hours, or any other time interval deemed appropriate by an operator of the IVER system. Longer intervals may be computationally efficient, while shorter intervals may ensure accuracy of the IVER system data records.

At 1606, the IVER system may synchronize the event status of the purchase event with a returned-value from the tracking data packet. In one example, the tracking data packet may return a value that indicates that a purchase event remains “pending.” In this example, the event status of the purchase event may remain “pending” until the lapse of a predetermined time interval that causes the event status to change to “abandoned.” In another example, the tracking data packet may return a value that indicates a “paid” event status associated with the purchase event; that is, a client has provided consideration (i.e. payment), as stipulated within the product-service offering. In this example, the event status of the purchase event may remain “paid” until the lapse of a predetermined time interval that causes the event status to change to “approved.”

At 1608, the IVER system may determine that a purchase event remains “pending” based on the value returned by the tracking data packet. In doing so, the IVER system may continue to monitor the purchase event for a predetermined time interval, until the purchase event is considered “abandoned.”

Further, at 1608, the IVER system may determine that the purchase event is “paid” based on the value returned by the tracking data packet. In doing so, the IVER system, at 1610, may determine that a commission benefit is payable to an account associated with the AP. The IVER system may calculate the commission benefit a fixed cost, a predetermined percentage of the value of the product-service offering, or as a combination of both.

At 1612, the IVER system may update an account balance associated with the AP to reflect a pending commission benefit that will be available once the purchase event has an approved event status. Thus, the IVER system may continue to monitor the purchase event for a predetermined time interval that allows for shipment and receipt of the product-service, or the lapse of a free-return warranty period associated with the product-service.

Returning to 1608, the IVER system may determine that the purchase event is “abandoned” based on the value returned by the tracking data packet. A purchase event may be considered abandoned if left unpaid for predetermined time interval. In doing so, the IVER system, at 1614, may cease monitoring the purchase event.

Again, returning to 1608, the IVER system may determine that the purchase event is “approved.” In one example, the IVER system may determine that the purchase event is “approved” based on the lapse of a predetermined time interval after purchase event has been paid. In another example, the IVER system may determine that the purchase event is “approved” at substantially the same time as payment is received for the product-service offering. In another example, the IVER system may determine that the event status of a purchase event is “approved” in response to a triggering event, such as delivery of a product offering, or completion of a service offering. Additionally, or alternatively, the triggering event may be associated with the manual uploading of a file associated with the purchase event, the file having data related to fulfillment of the product-service offering.

In doing so, the IVER system, at 1616, may cause the transfer of the commission benefit to an account associated with the AP. In one example, the IVER system may automatically transfer the commission benefit once the purchase event is “approved.” In another example, the IVER system may make the commission benefit available to the AP, and subsequently transfer the commission benefit in response to receiving such instruction from the AP.

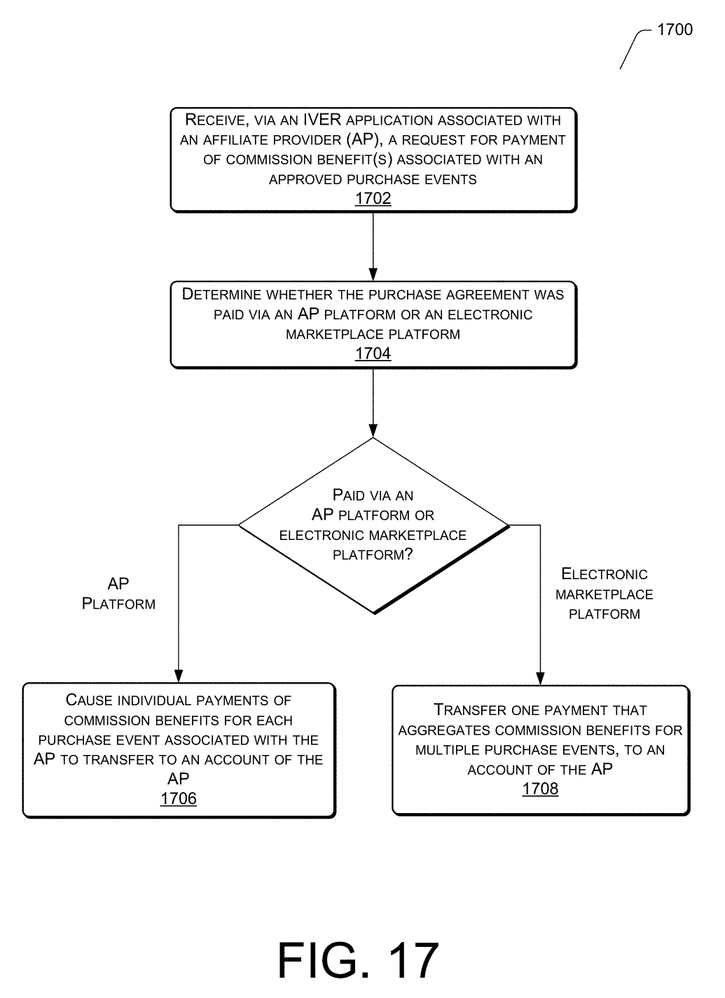

FIG. 17 illustrates an IVER system process that facilitates payment of a commission benefit in response to approval of a purchase event. In one example, the IVER system may process individual payments of commission benefits for individual purchase events. The IVER system may adopt this first process to comply with financial regulations associated with an AP electronic storefront, such as an AP platform. Alternatively, the IVER system may process one payment that aggregates the commission benefits of multiple purchase events. The IVER system may adopt this second process for AP electronic storefronts associated with electronic marketplace platforms.

An AP platform may be a platform through which an AP offers an exclusive selection of product-service offerings, such as a website exclusively associated with the AP. In contrast, an electronic marketplace platform may be a non-exclusive platform through which multiple APs offer product-service offerings.

At 1702, the IVER system may receive a request for payment of commission benefits associated with approved purchase events. The commission benefits may correspond to a single purchase event, or multiple purchase events. Further, the commission benefits may be associated with purchase events transacted via an AP platform or an electronic marketplace platform.

At 1704, the IVER system may determine whether payment has been received for the purchase event at an AP platform or an electronic marketplace platform. In doing so, the IVER system may determine whether multiple commission benefits may be aggregated into a single payment transfer, or whether individual payments of commission benefits are mandated for each purchase event. For example, the IVER system may process individual payments of commission benefits for individual purchase events to comply with financial regulations associated with an AP platform. On the other hand, the IVER system may aggregate the commission benefits of multiple purchase events that are processed via an electronic marketplace platform.

At 1706, the IVER system may determine that payment has been received for a purchase event at an AP platform. In doing so, the IVER system may cause individual payments of commission benefits for each purchase event to transfer to an account designated by the AP.

At 1708, the IVER system may determine that payment has been received for a purchase event at an electronic marketplace platform. In doing so, the IVER system may aggregate the commission benefits for multiple purchase events associated with the AP over a predetermined time interval. Thus, the IVER system may transfer one payment of the aggregated commission benefits to an account designated by the AP.

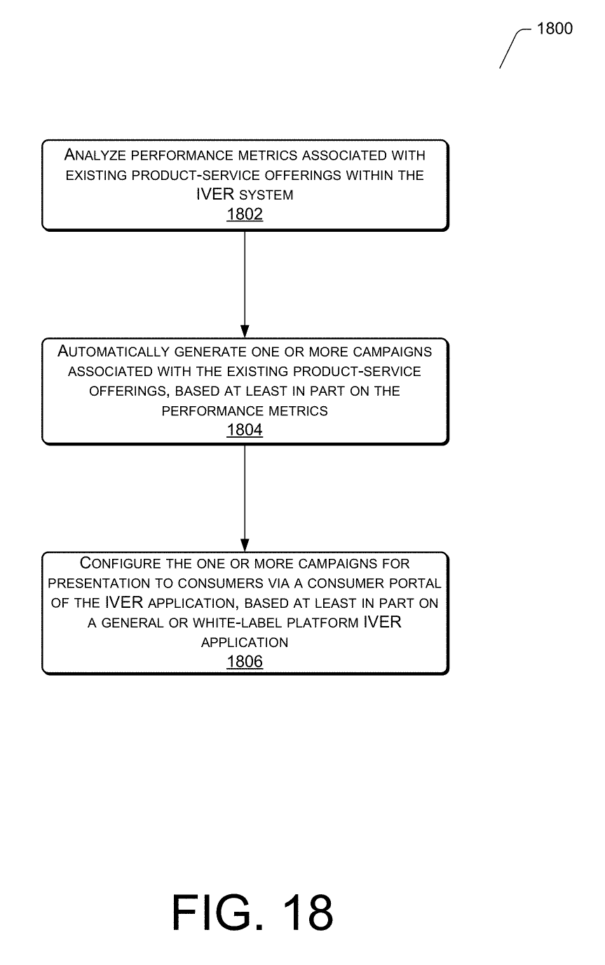

FIG. 18 illustrates an IVER system process to generate a list of existing campaigns based at least in part on performance metrics. The listing of existing campaigns may be based on product-service campaigns presented within a general platform of an IVER application or a white-label platform of an IVER application.

At 1802, the IVER system may analysis performance metrics associated with existing product-service offerings within the IVER system. Each product-service offering may be associated with particular AP electronic storefronts that are part of a product-service campaign. The association between an AP, product-service campaign, and product-service offering is described in greater detail with reference to FIGS. 5A, 5B, and 5C. Further, the performance metrics may include, but are not limited to, most shared product-service offerings, most clicked product-service offerings, most purchased product-service offerings, highest commission product-service offerings, or any combination thereof. In some examples, the performance metrics may be normalized to account for product-service campaigns that have been active for different period of time. Further, performance metrics may be based on product-service campaign data over a predetermined time period.

At 1804, the IVER system may automatically generate one or more product-service campaigns associated with existing product-service offerings, based at least in part on the performance metrics. For example, the IVER system may generate one or more product-service campaigns based on most shared product-service offerings, most clicked product-service offerings, most purchased product-service offerings, highest commission product-service offerings, or any combination thereof. Each product-service offering within the product-service campaigns may be accessible to consumers via the consumer portal of an IVER application, and more specifically via the Uniform Resource Locator (URL) link with the product-service offering.

At 1806, the IVER system may configure the one or more product-service campaigns for presentation to consumers via a consumer portal of the IVER application, based at least in part on whether each product-service offering is associated with a general platform of an IVER application or a white-label of an IVER application. For example, consider a product-service offering that is included in a product-service campaign of most-clicked product-service offerings. If the product-service offering is associated with a general platform of an IVER application, the IVER system may omit the product-service offering from a product-service campaign of most-clicked product-service offerings that is presented on a white-label platform of an IVER application if the AP associated with the product-service campaign is not affiliated with the white-label platform.

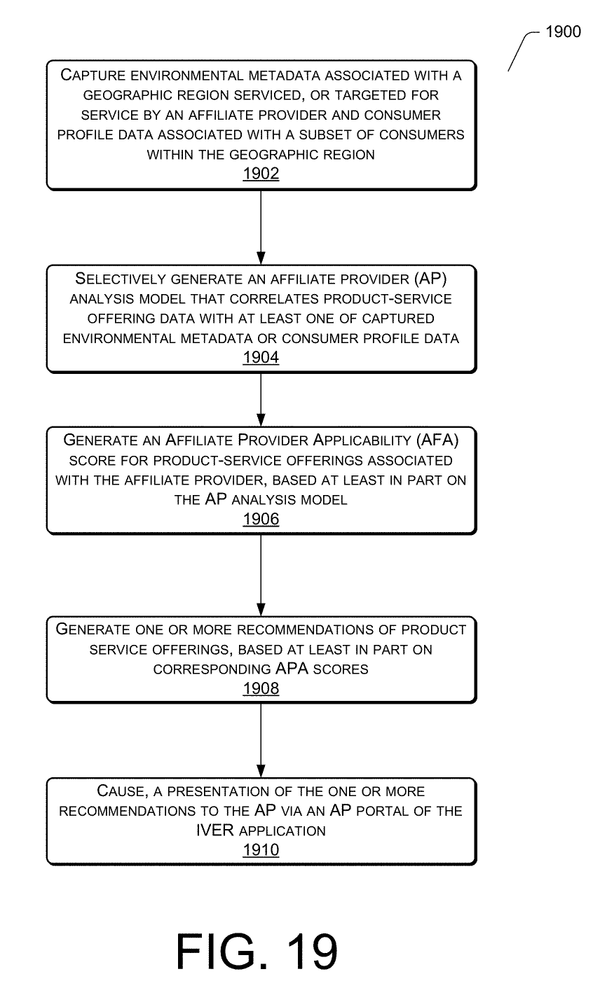

FIG. 19 illustrates an IVER system process for generating, via an Affiliate Provider (AP) analysis model, one or more recommendations of product-service offerings for a subset of consumers. In various examples, the AP analysis model may be based on environmental metadata associated with a geographic region serviced or targeted for service by an AP. Alternatively, or additionally, the AP analysis model may be based on consumer profile data.

At 1902, the IVER system may capture environmental metadata associated with a geographic region serviced or targeted for service by an AP. The IVER system may further capture consumer profile data associated with a subset of consumers within the geographic region. The subset of consumers may be determined based on a frequency of visits or residence within the geographic area, or a degree of correlation between consumer profile data and product-service offerings.

At 1904, the IVER system may selectively generate an AP analysis model that correlates product-service offering data with at least one of captured environmental metadata or consumer profile data. The IVER system may employ one or more trained machined learning algorithms to generate AP analysis model. More specifically, AP analysis model may be based on a combination of historical product-service transaction data, consumer profile data, and historical environmental metadata over a predetermined time interval.

In doing so, the IVER system may use the AP analysis model to analyze the environmental metadata and consumer profile data captured in real-time, and further identify correlations with historical instances of product-service transactions.

At 1906, the IVER system may generate an AP Applicability (APA) score for product-service offerings associated with the AP, based at least in part on the AP analysis model. The APA score may be configured to reflect a degree of correlation between current product-service offerings and historical product-service transactions. A high APA score (i.e. 7 to 10, high, or green) may reflect a high degree of correlation relative to a low APA score (i.e. 3 to 5, low, or red).

At 1908, the IVER system may generate one or more recommendation of product-service offerings, based at least in part on corresponding APA scores. For example, the IVER system may be configured to generate a recommendation for each product-service offering with an APA score that is greater than or equal to a predetermined threshold. The predetermined threshold may be set by the AP or an operator of the IVER system. In one example, the predetermined threshold may correspond to a medium APA score (i.e. 4 to 6, medium, or yellow). In another example, the predetermined threshold may correspond to a high APA score (i.e. 7 to 10, high, or green).

At 1910, the IVER system may cause a presentation of the one or more recommendations to the AP via an AP portal of the IVER application. The recommendations may relate to refining the set of consumers, to a subset of consumers, that may be likely to initiate or complete a purchase transaction for a particular product-service offering. Recommendations may also relate to identifying particular product-service offerings associated with the AP that may appeal to the set of consumers, or better tailoring aspects of product-service offerings to appeal to the set of consumers. Regarding the latter, a recommendation may suggest a discount to a product-service offering within a geographic area based on any economy of data (i.e. environmental metadata) relating to the set of consumers.

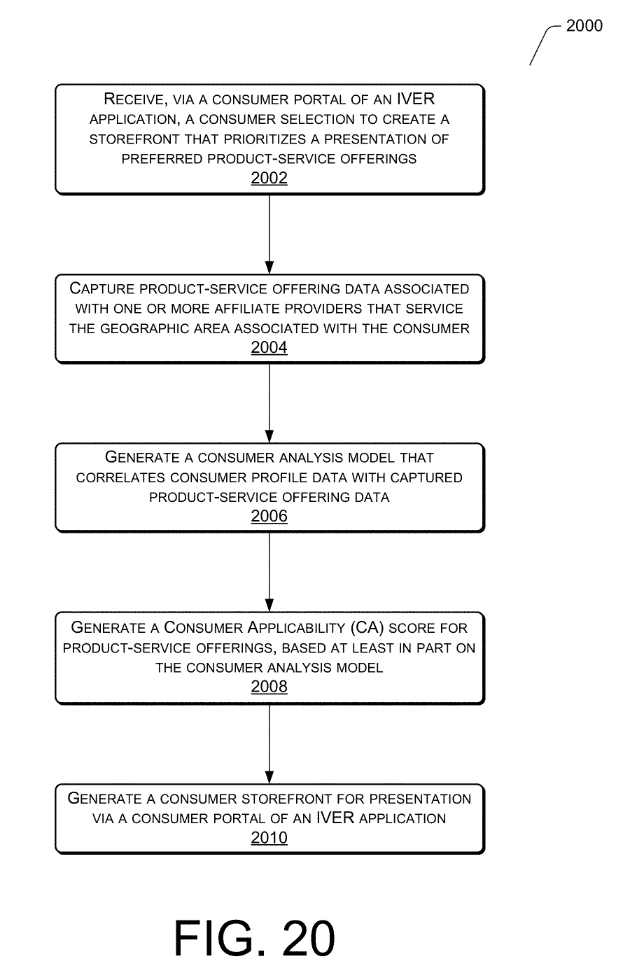

FIG. 20 illustrates an IVER system process for facilitating a consumer generating a consumer storefront at a consumer portal of an IVER application that prioritizes a presentation of consumer-preferred product-service offerings.

At 2002, the IVER system may receive, via a consumer portal of an IVER application, a consumer selection to create a consumer storefront that prioritizes a presentation of preferred product-service offerings. A consumer selection may be based on a category of products or services or one or more product-service campaigns.

At 2004, the IVER system may capture product-service offering data associated with one or more APs that service the geographic area associated with the consumer. In one example, the IVER system may capture the product-service offering data from within a data store of the IVER system. The product-service offering data may relate to existing product-service campaigns that an AP presents via the IVER system.

At 2006, the IVER system may generate a consumer analysis model using any combination of a record of historical product-service transaction data executed by the consumer, a record of product-service offerings viewed via an IVER application (i.e. consumer portal) by the consumer, profile data associated with the consumer, or the consumer storefront selection of preferred categories/campaigns of product-services. The consumer analysis model may be based on the above-referenced historical data over a predetermined time interval, and continuously evaluated to progressively refine the consumer analysis model. As more data becomes available, a continuously more accurate consumer analysis model may be developed.

At 2008, the IVER system may generate a Consumer Applicability (CA) score for product-service offerings associated with the one or more APs, based at least in part on the consumer analysis model. The CA score may reflect a degree of correlation between existing product-service offering data associated with one or more APs and the consumer analysis model. A high CA score (i.e. 7 to 10, high, or green) may reflect a high degree of correlation relative to a low CA score (i.e. 3 to 5, low, or red).

At 2010, the IVER system may generate a consumer storefront for presentation via a consumer portal of an IVER application associated with the consumer. The consumer storefront may selectively prioritize a presentation of product-service offerings based at least in part on their respective CA scores. For example, the IVER system may prioritize presentation of product-service offerings with high CA scores (i.e. 7 to 10, high, or green) before presenting product-service offerings with medium CA scores and then (i.e. (i.e. 4 to 6, medium, or yellow), which are further prioritized before presenting product-service offerings with low CA scores (i.e. 3 to 5, low, or red).

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed:

1. A system comprising:
one or more processors;
memory coupled to the one or more processors, the memory including one or more modules that are executable by the one or more processors to:
receive, from a first client device associated with an affiliate provider, a request to present a product-service campaign via a consumer portal of a particular application, the product-service campaign corresponding to a particular product or service, the consumer portal of the particular application being accessible via a second client device;
retrieve, from a data store, one or more product-service offerings associated with the product-service campaign;
generate a product-service campaign associated with the particular product or service, based at least in part on the one or more product-service offerings; and
cause a user interface of the second client device to present the product-service campaign via the consumer portal of the particular application.

2. The system of claim 1, wherein the one or more modules are further executable by the one or more processors to:
receive, from the first client device, a registration request to present the one or more product-service campaigns on the particular application, the registration request including at least an affiliate provider identifier;
authenticate an identity of the affiliate provider based at least in part on the affiliate provider, and
wherein to present the one or more product-service campaigns on the particular application is further based at least in part on authentication of the identity of the affiliate provider.

3. The system of claim 1, wherein the request further includes a campaign identifier, and wherein the one or more modules are further executable by the one or more processors to:
determine that the product-service campaign is to be presented via a general platform of the particular application, based at least in part on the campaign identifier, the general platform being configured to present the product-service campaign with a plurality of product-service offerings from a plurality of affiliate providers, and
wherein, the product-service campaign further includes the plurality of product-service offerings from the plurality of affiliate providers.

4. The system of claim 1, wherein the request further includes a campaign identifier, and wherein the one or more modules are further executable by the one or more processors to:
determine that the product-service campaign is to be presented via a white-label platform of the particular application, based at least in part on the campaign identifier, the white-label platform being configured to present the product-service campaign with a plurality of product-service offerings from the affiliate provider; and
filter a subset of product-service offerings from the one or more product-service offerings that are associated with the affiliate provider, and
wherein the product-service campaign is further based at least in part on the subset of product-service offerings.

5. The system of claim 1, wherein the one or more product-service offerings correspond to an offering of the particular product or service at individual electronic storefronts, the individual electronic storefronts corresponding to affiliate provider platform that presents product-service offerings exclusively associated with the affiliate provider or an electronic marketplace platform that is configured to present a plurality of product-service offerings from a plurality of affiliate providers.

6. The system of claim 1, wherein the one or more modules are further executable by the one or more processors to:
receive a first indication from the second client device indicating that a purchase event associated with a product-service offering of the one or more product-service offering has been initiated;
transmit a data packet to an electronic storefront associated with the product-service offering, the data packet including a tracking data-set that is intended to monitor progress of the purchase event, the tracking data set including an affiliate provider identifier;
receive a second indication from the electronic storefront indicating that the purchase event has been executed; and
cause a payment of a commission benefit to be executed into an account associated with the affiliate provider, based at least in part on execution of the purchase event and the affiliate provider identifier.

7. The system of claim 1, wherein the consumer is a first consumer and wherein, one or more modules are further executable by the one or more processors to:
receive a first indication from the second device associated with the first consumer that a product-service offering of the one or more product-service offerings has been referred to a second consumer associated with a third client device;
transmit a data packet to the third client device that includes a tracking data-set, the tracking data-set intended to detect whether a purchase event has been executed by the second client device, the data packet including a first consumer identifier;
receive a second indication from the third client device indicating that a purchase event has been executed; and
cause a payment of a commission benefit to be executed into an account associated with the first consumer, based at least in part on execution of the purchase event and the first consumer identifier.

8. The system of claim 1, wherein the particular application is native to the second client device that is associated with a consumer, or wherein the particular application is accessible via a web-based portal by the second client device.

9. One or more non-transitory computer-readable media storing computer-executable instructions that, when executed on one or more processors, cause the one or more processors to perform acts comprising:
receiving, from a first client device associated with an affiliate provider, a request to present a product-service campaign via a consumer portal of a particular application, the product-service campaign corresponding to a particular product or service, the consumer portal of the particular application being accessible via a second client device;
generating a product-service campaign associated with the particular product or service, based at least in part on one or more product-service offerings; and
causing a user interface of the second client device to present the product-service campaign via the consumer portal of the particular application.

10. The one or more non-transitory computer-readable media of claim 9, further comprising:
accessing one or more electronic storefronts that offer the particular product or service; and
retrieve, from the one or more electronic storefronts, the one or more product-service offerings associated with the product-service campaign

11. The one or more non-transitory computer-readable media of claim 9, further comprising:
receiving, from the first client device, a registration request to present the one or more product-service campaigns on the particular application, the registration request including at least an affiliate provider identifier;
authenticating an identity of the affiliate provider based at least in part on the affiliate provider, and
wherein, causing the user interface of the second client device to present the one or more product-service campaigns on the particular application is further based at least in part on authentication of the identity of the affiliate provider.

12. The one or more non-transitory computer-readable media of claim 9, further comprising:
determining that the product-service campaign is to be presented via a general platform of the particular application, based at least in part on a campaign identifier, the general platform being configured to present the product-service campaign with a plurality of product-service offerings from a plurality of affiliate providers, and
wherein, the product-service campaign further includes the plurality of product-service offerings from the plurality of affiliate providers.

13. The one or more non-transitory computer-readable media of claim 9, wherein the request further includes a campaign identifier, and further comprising:
determining that the product-service campaign is to be presented via a white-label platform of the particular application, based at least in part on the campaign identifier, the white-label platform being configured to present the product-service campaign with a plurality of product-service offerings from the affiliate provider; and
filtering a subset of product-service offerings from the one or more product-service offerings that are associated with the affiliate provider, and
wherein the product-service campaign is further based at least in part on the subset of product-service offerings.

14. The one or more non-transitory computer-readable media of claim 9, wherein the affiliate provider corresponds to a merchant, vendor, or seller of the particular product or service that is associated with the product-service campaign.

15. The one or more non-transitory computer-readable media of claim 9, further comprising:
receiving a first indication from the second client device indicating that a purchase event associated with a product-service offering of the one or more product-service offering has been initiated;
transmitting a data packet to an electronic storefront associated with the product-service offering, the data packet including a tracking data-set that is intended to monitor progress of the purchase event, the tracking data set including an affiliate provider identifier;
receiving a second indication from the electronic storefront indicating that the purchase event has been executed; and
causing a payment of a commission benefit to be executed into an account associated with the affiliate provider, based at least in part on execution of the purchase event and the affiliate provider identifier.

16. A computer-implemented method, comprising:
under control of one or more processors:
receiving, from a first client device associated with an affiliate provider, a request to present a product-service campaign via a consumer portal of a particular application, the product-service campaign corresponding to a particular product or service, the consumer portal of the particular application being accessible via a second client device;
generating a product-service campaign associated with the particular product or service, based at least in part on one or more product-service offerings; and
causing a user interface of the second client device to present the product-service campaign via the consumer portal of the particular application.

17. The computer-implemented method of claim 16, wherein the one or more product-service offerings correspond to an offering of the particular product or service at individual electronic storefronts, the individual electronic storefronts corresponding to affiliate provider platform that presents product-service offerings exclusively associated with the affiliate provider or an electronic marketplace platform that is configured to present a plurality of product-service offerings from a plurality of affiliate providers.

18. The computer-implemented method of claim 16, further comprising:
receiving a first indication from the second client device indicating that a purchase event associated with a product-service offering of the one or more product-service offering has been initiated;
transmitting a data packet to an electronic storefront associated with the product-service offering, the data packet including a tracking data-set that is intended to monitor progress of the purchase event, the tracking data set including an affiliate provider identifier;
receiving a second indication from the electronic storefront indicating that the purchase event has been executed; and
causing a payment of a commission benefit to be executed into an account associated with the affiliate provider, based at least in part on execution of the purchase event and the affiliate provider identifier.

19. The computer-implemented method of claim 16, wherein the consumer is a first consumer and further comprising:
receiving a first indication from the second device associated with the first consumer that a product-service offering of the one or more product-service offerings has been referred to a second consumer associated with a third client device;
transmitting a data packet to the third client device that includes a tracking data-set, the tracking data-set intended to detect whether a purchase event has been executed by the second client device, the data packet including a first consumer identifier;
receiving a second indication from the third client device indicating that a purchase event has been executed; and
causing a payment of a commission benefit to be executed into an account associated with the first consumer, based at least in part on execution of the purchase event and the first consumer identifier.

20. The computer-implemented method of claim 16, wherein the particular application is native to the second client device that is associated with a consumer, or wherein the particular application is accessible via a web-based portal by the second client device.
